(19) United States
(12) Patent Application Publication
(10) Pub. No.: US 2005/0217537 A1
(43) Pub. Date: Oct. 6, 2005

(54) Formulations and methods for rendering materials flame retardant and resistant to molds and insects

(76) Inventor: Eric Von Knipe, Beverly Hills, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/074,824

(22) Filed: Mar. 8, 2005

Related U.S. Application Data
(60) Provisional application No. 60/552,025, filed on Mar. 9, 2004.

(51) Int. Cl. C09D 5/16; C08K 5/00

(52) U.S. Cl. 106/493; 252/606

(57) ABSTRACT

Preferred embodiments of the present invention are directed to formulations and methods for treating materials, including wood, cellulose and paper products, especially building materials, to beautify and strengthen the materials and to render the materials flame retardant and resistant to damage from molds and insects. More particularly, the formulations include washes, and a variety of coatings, including primers, sealers and paints, that include an effective amount of a boron-containing aqueous solution.

### RELATED APPLICATIONS

This application claims priority under 35 U.S.C. §119(e) to U.S. Provisional Application No. 60/552,025 filed on Mar. 9, 2004.

### BACKGROUND OF THE INVENTION

1. Field of the Invention

Preferred embodiments of the present invention are directed to formulations and methods for treating materials, including wood, cellulose and paper products, especially building materials, to beautify and strengthen the materials and to render the materials flame retardant and resistant to damage from molds and insects. More particularly, the formulations include washes, and a variety of coatings, including primers, sealers and paints.

2. Description of the Related Art

Typically, wood and other cellulose products such as plywood and oriented strand board (OSB), are exposed to a wide range of weather and environmental conditions. During the useful lifetimes of such materials, they may also become exposed to molds and fungi, and/or they may become damaged by various boring or wood-eating insects. Such exposure to fungi and insects hastens the degradation of the materials and the building structures. Materials may also be exposed to fire, damaging the materials and structural integrity of the buildings and obviously increasing the risk of loss of life and property.

In North America, most residential buildings use wood frame structures for the structural skeleton and wood panels for shear strength. In many areas, homes are protected against subterranean termites by treating the soil under homes prior to construction and by treating the soil around existing homes and/or by treating the structure itself when termites are detected. Soil treatment methods were largely effective for subterranean termites when organochlorine pesticides such as chlordane were used. Due to environmental concerns, these termiticides were removed (effectively banned) from the marketplace in the late-1980s. The next generation termiticides have shown to be less effective and durable, leading to termite infestations in relatively new structures.

The damage caused by termites, mold and other wood destroying organisms to wood framed buildings is significant and growing. In 1998, termites, decay and other wood destroying organisms were estimated to have caused over $3 billion in damage to buildings. This increased from $750 million in 1988. While the economic consequence of wood degradation is significant and growing, consumers are demanding more durable, higher quality homes. Builders note that the most profound change in the marketplace is that homebuyers have become more educated and maintenance adverse, placing a higher premium than ever before on quality construction and the reputation of the builder. This raises business and liability issues for builders and material suppliers, and opportunities to address these issues.

Fire is the third leading cause of accidental death in the home; at least 75% of all deaths due to fire occur in residences. The United States has one of the highest fire death rates, per capita, in the industrialized world. Approximately 6,000 people die and 30,000 people are injured in fires annually in the U.S. Each year, fire kills more Americans than all the major natural emergencies combined including floods, tornadoes and earthquakes. Direct property loss due to fire is estimated at $11.2 billion annually. The total cost of fires to the American public is about $50 billion per year.

Methods and compositions for treating wood and cellulose materials to provide at least some protection against such conditions are known in the art. In one such method, materials are treated with a composition comprising sodium sulfate and ammonium pentaborate. This composition is generally obtained as a result of the reaction between sodium borates (borax) and ammonium sulfate in water. However, ammonium pentaborate is soluble in water. Therefore, the composition gradually leaches out of the treated wood or cellulose upon repeated exposure to outdoor moisture, such as rain.

Over the years, much effort has been directed to solving the problem of imparting fire-inhibiting properties to wood, as well as resistance to the growth of fungi, attack by termites, and moisture. Initial efforts, aimed at imparting fire-inhibiting properties to wood, included impregnation of the wood with fire-inhibiting salts that are applied in an aqueous solution. For example, ammonium sulfate, sodium sulfate or magnesium sulfate, monoammonium phosphate or diammonium phosphate, borates, or the like have been used. The fire-inhibiting or flame retardant effect of such salts may be based on the fact that their decomposition is endothermic and that on being heated, they easily form salts which envelop the inflammable substance, so that combustible gases are not given off, and the wood carbonizes without any flames being formed. The use of such salts has a shortcoming, however, as even though they could easily impregnate the wood, they were rather easily washed out of the wood again due to their excellent water solubility.

U.S. Pat. No. 3,935,341 to Sorensen et al. discloses another method of imparting fire and pest resistance to wood. This method renders wood fire resistant by impregnating the wood with a solution of phenol and a fire-inhibiting salt, drying the wood, followed by treating the wood with a solution of formaldehyde which is polymerizable with the phenol. Heating the treated wood to dryness causes polymerization of the monomers. Wood products, such as those disclosed by Sorensen et al., have fallen out of favor in recent years due to the potential toxic environmental effects of residual formaldehyde in the treated wood.

U.S. Pat. Nos. 3,945,835 and 4,038,086 to Clarke et al. and U.S. Pat. No. 4,103,000 to Hartford disclose various aqueous wood treating and/or preservative compositions that contain copper ammonium and/or zinc ammonium cations and arsenic or arsenious anions, to make, for example, chromated copper arsenate wood treating compositions. While effective at preserving wood, these materials are able to be leached from the wood by water and, owing to the toxic nature of the compositions, can create a potential to harm the environment.

U.S. Pat. No. 3,974,318 to Lilla discloses a process whereby water soluble silicate compositions are applied to a wood product, and the product is subsequently treated with a water soluble metallic salt compound to form a water insoluble metallic silicate in the wood product. Improvements on this method have been disclosed in U.S. Pat. No. 5,478,598 to Shiozawa, and U.S. Pat. Nos. 6,146,766 and 6,040,057 to Slimak et al. However, in these cases, the silicate based treatment compositions can be leached from the wood by exposure to environmental water and moisture, which eventually causes the treated wood to loose its fire, insect, termite, and microbial attack resistance. U.S. Pat. No. 6,235,349 to Grantham et al. discloses further improvements utilizing a wood treating composition that includes a silicate, a wetting agent and a rheology modifier. However, this approach also has its limitations.

Accordingly, there is an ongoing, long-felt need for an environmentally safe composition and method for treating materials to render them flame retardant, as well as resistance to the growth of mold, fungi, attack by termites and other insects, and moisture, especially lumber and wood-based building materials, wherein the treatment formulation is resistant to being removed or leached from the treated materials due to exposure to environmental water and moisture.

### SUMMARY OF THE INVENTION

A composition for rendering a wood or wood product flame retardant and resistant to molds and insects is disclosed. The composition comprises a metallic borate, a methyl donor, an aliphatic short-chain alcohol, an acid, and an ammonium base.

In preferred embodiments of the composition, the metallic borate is selected from the group consisting of disodium tetraborate decahydrate, disodium octaborate tetrahydrate, sodium metaborate, sodium perborate monohydrate, disodium octaborate, sodium tetraborate pentahydrate, sodium tetraborate, copper metaborate, potassium borate and zinc borate. Preferably, the concentration of the metallic borate is up to about 90% by weight, and more preferably, between about 5 to 15% by weight.

In preferred embodiments of the composition, the methyl donor may be one or both of the compounds selected from the group consisting of tetramethylglycine and trimethylglycine. Preferably, the total concentration of the methyl donor ranges from about 0% to about 30% by weight, and more preferably, about 5% by weight.

In preferred embodiments of the composition, the alcohol is selected from the group consisting of methanol, ethanol, butanol, propanol, isopropanol, pentanol, hexanol, heptanol and ester alcohols, e.g., TEXANOL. Preferably, the concentration of the alcohol is up to about 40% by weight, and more preferably, between about 1-15% by weight.

In preferred embodiments of the composition, the acid is a mineral acid, selected from the group consisting of hydrochloric acid, phosphoric acid and hydrobromic acid. Preferably, the concentration of the mineral acid is up to about 30% by weight, and more preferably, between about 1-5% by weight.

In other preferred embodiments, the composition further comprises urea. Preferably, the concentration of the urea is between about 0 and 25% by weight, and more preferably, between about 0 and 10% by weight.

In other preferred embodiments, the composition further comprises an insecticidal and/or antifungal agent, selected from the group consisting of DOWCIL-75, parabens, methyl paraben, propyl paraben, disodium cyanodithioimidocarbonate, methylene bis thiocyanate; isothiazolin, glutaraldehyde, dithiocarbamates, quaternary ammonium compounds, dibromonitrilopropionamide, dibromo dicyano butane, dodecylguanidine hydrochloride, organophosphate compounds, malathion, ethl-parathion, diazinon, organosulfur insecticides, tetradifon, propargite, ovex, carbamate compounds, carbaryl, methomyl, carbofuran, aldicarb, oxamyl, thiodicarb, methiocarb, propoxur, bendiocarb, carbosulfam, aldoxycarb, 3-iodo-2-propynyl butyl carbamate, promecarb, fenoxycarb, formamidine insecticides, amitraz, dinitropheol compounds, 2,4-dinitrophenol, organotin insecticides, cyhexatin, pyrethroid compounds, allethrin, tetramethrin, fenvalerate, acrinathrin, permethrin, nicotinoid compounds, 1-(6-chloro-3-pyridin-3-ylmethyl)-n-nitro-imidazolidin-2-ylidenamine, phenol compounds, 2-phenylphenol and mixtures thereof.

The concentration of the insecticidal and/or antifungal agent is preferably between about 0 and 30% by weight, and more preferably, between about 0 and 10% by weight.

In other preferred embodiments, the composition further comprises a coupling agent selected from the group consisting of glycol ethers, linear or branched C1-C12 alcohols, linear or branched C1-C12 acetates, alkali salts of alkyl, aryl, or alkylaryl sulfonates, betaine surfactants, fatty acids, and ketones and mixtures thereof.

In other preferred embodiments, the composition further comprises a foaming agent.

In other preferred embodiments, the composition further comprises a rheology modifier.

In other preferred embodiments, the composition further comprises a surfactant.

A wash for treating wood or wood products is disclosed in accordance with one preferred embodiment of the present invention. The wash comprises any of the above-described boron-containing compositions.

A waterproofing formulation for treating wood or wood products is disclosed in accordance with one preferred embodiment of the present invention. The waterproofing formulation comprises a conventional sealer further comprising any of the above-described boron-containing compositions.

A primer for covering wood or wood products is disclosed in accordance with one preferred embodiment of the present invention. The primer comprises a conventional primer formulation further comprising any of the above-described boron-containing compositions.

A paint for covering wood or wood products is disclosed in accordance with one preferred embodiment of the present invention. The paint comprises a conventional paint formulation further comprising any of the above-described boron-containing compositions.

A method for treating or preventing fungal growth on a material is disclosed in accordance with one embodiment of the present invention. The method comprises the step of applying to the material an amount of any of the above-described boron-containing compositions effective in treating or preventing the fungal growth.

A method for treating or preventing insect infestation on a material is disclosed in accordance with one embodiment of the present invention. The method comprises the step of applying to the material an amount of any of the above-described boron-containing compositions effective in treating or preventing the insect infestation.

A method for rendering a material flame retardant is disclosed in accordance with one embodiment of the present invention. The method comprises the step of applying to the material an amount of any of the above-described boron-containing compositions effective in rendering the material flame retardant.

A method for rendering a material resistant to fungal growth, insect infestation and flame spread is disclosed in accordance with one embodiment of the present invention. The method comprises the step of applying to the material an amount of any of the above-described boron-containing compositions effective in rendering the material resistant to fungal growth, insect infestation and flame spread.

A material, which has been rendered resistant to fungal growth, insect infestation and flame spread, is disclosed in accordance with one preferred embodiment of the present invention. The material is rendered resistant to fungal growth, insect infestation and flame spread by the process of applying to the material an amount of any of the above-described boron-containing compositions effective in rendering the material resistant to fungal growth, insect infestation and flame spread. In one preferred embodiment, the process of applying further comprises pressure-treating the material. In another preferred embodiment, process of applying further comprises slurrying a wood-derived precursor material in the presence of a glue. In preferred embodiments, the material is green lumber, engineered wood, treated wood, OSB, or paper.

A system for treating materials is also disclosed in accordance with a preferred embodiment of the present invention. The system comprises a wash, a primer and a paint, each comprising any of the above-described boron-containing compositions.

### BRIEF DESCRIPTION OF THE DRAWINGS

FIG. 1 shows drill-hole locations for a 4″×10″ structural beam.

FIG. 2 shows alternate drill-hole locations for a 4″×10″ structural beam.

### DETAILED DESCRIPTION OF THE PREFERRED EMBODIMENT

The formulations and methods disclosed herein are useful in rendering materials, particularly wood-based (see definition below) building materials used in construction, flame retardant and resistant to decay (wet and dry), fungi and insects. One composition in accordance with a preferred embodiment of the present invention is a flame-retardant, fungicidal and insecticidal boron-containing aqueous solution (hereinafter “BCAS”). In its broadest embodiments, BCAS comprises a borate, a methyl donor (e.g., choline (tetramethylglycine), betaine (trimethylglycine), etc.), a short-chain aliphatic alcohol, an acid, and an ammonium base. In variations, BCAS may optionally comprise urea. In further variations, BCAS may optionally comprise one or more additional antifungal and/or insecticidal agents. BCAS can be used for some applications as is, or preferably, formulated into a variety of products used to treat materials and impart thereupon a desirable property, including without limitation, flame and/or fire retardant, anti-microbial, anti-fungal, anti-bacterial, insecticidal, termicidal (anti-termite), termite resistant and moisture resistant. The products may include without limitation:
a wash for treating and preventing fungal growth, and common household molds
an insecticidal treatment for treating and preventing insect infestation
a primer or undercoat for applying to materials before painting
a preservative for treating materials
a stain for treating and beautifying materials
a sealer for treating and rendering moisture-resistant
a paint

Unless otherwise indicated, all numbers or expressions referring to quantities of ingredients, reaction conditions, etc., used herein are to be understood as modified in all instances by the term “about.” Unless expressly indicated otherwise, the various numerical ranges specified in this application are approximations. Various numerical ranges are disclosed in this patent application. Because these ranges are continuous, they include every value between the minimum and maximum values.

As used herein and in the claims, the term “solution” refers to any homogeneous mixture of at least one material in a solvent. The term “solution” is not meant to exclude heterogeneous mixtures, where the material may not be completely miscible in the solvent, but is uniformly dispersed therein, or may become uniformly dispersed therein with the application of moderate mixing.

As used herein and in the claims, the term “water insoluble” refers to materials that do not readily form homogeneous solutions in water. Generally, if distinct particulates are visible at a concentration of 0.1 g/100 g of distilled water at a pH of from 6.0-8.0, the material will be considered water insoluble.

Preferred embodiments of the present invention are generally directed to compositions and methods for the treatment of wood and wood products which preserves the wood substrate or products thereof and renders the wood substrate or products thereof resistant to fire, moisture, fungus, termites, and other insects.

As used herein and in the claims, the term “wood products” refers generally to products derived from wood, which includes, but is not limited to, oriented strand board (OSB), medium-density fiberboard (MDF), plywood, particleboard, paper products, natural wood products including both green and dried lumber, as well as products made or derived from wood chips, wood pulp, and/or wood fiber. The term “wood” includes green lumber. The treated wood products are generically useful for construction purposes, general construction methods, and as general construction materials. More specifically, for purpose of example only, the treated products may be used in flooring, fire doors, exterior beams and columns, fire panel materials and sheeting, and exterior sheeting, including siding, cabinet manufacturing, furniture manufacturing, railroad cross ties, landscape timbers, floor plating, fire-retardant lumber, door jambs, sea walls, countertops, exterior fascia material, and in window manufacturing. Other substrates upon which the present method may be applied include, but are not limited to, paper, cardboard, paper towels, sponges, porous plastics, and fabrics.

As used herein, the term “green lumber” refers to wood that has a moisture content of at least 40%. The moisture content of the wood, usually expressed in a percentage, is a ratio of the amount of water in a piece of wood compared to the weight of such wood when all of the moisture has been removed. The moisture content may be determined by the moisture content on oven-dry basis method. In this method, the moisture content of wood is determined by weighing a given sample of wood (wet weight), placing it into an oven at a temperature not to exceed 100° C., until all of the moisture has been removed from the wood (the “oven-dry weight”). The oven-dry weight is then subtracted from the wet weight and the resultant is then divided by the oven-dry weight. The resultant figure is then multiplied by 100 to determine the moisture content percentage. When a tree, such as red or white oak, fir, maple, spruce, ash, southern yellow pine, or any one of the many species of trees that yield wood, that is useful in the production of wood products is initially cut down, it has a moisture content of anywhere from about 60% to 100%.

Boron-Containing Aqueous Solution (“BCAS”)

As indicated above, BCAS comprises: (1) a borate, (2) a methyl donor (e.g., choline (tetramethylglycine), betaine (trimethylglycine), etc.), (3) a short-chain aliphatic alcohol, (4) an acid, and (5) an ammonium base. In variations, BCAS may optionally comprise (6) urea. In further variations, BCAS may optionally comprise one or more additional (7) anti-fungal and/or insecticidal agents.

In embodiments of the present invention, the boron compound in BCAS is selected from the group consisting of perborates, metaborates, tetraborates, octaborates, and borate esters. More preferably, the boron compound comprises metallic borates, such as disodium tetraborate decahydrate, disodium octaborate tetrahydrate, sodium metaborate, sodium perborate monohydrate, disodium octaborate, sodium tetraborate pentahydrate, sodium tetraborate, copper metaborate, potassium borate, and zinc borate. One of the benefits of using a metallic borate is its chemical stability over time. It does not break down, thus providing long-lasting wood protection and residual pest control activity.

The boron compound may be present in BCAS at a concentration up to about 90% by weight. More preferably, the boron compound is present at about 2 to 75% by weight. Most preferably, the boron compound is present at a concentration sufficient to yield a boric acid equivalent of between about 5 to 15% by weight.

Any methyl donor may be used in accordance with embodiments of the present invention. In preferred embodiments, the methyl donor may be selected from the group consisting of choline (tetramethylglycine) and betaine (trimethylglycine). The methyl donor may be present in BCAS at a concentration of from about 0.01% to about 30% by weight. More preferably, the methyl donor is present up to about 15% by weight. Most preferably, the methyl donor is present at about 5% by weight.

The preferred short-chain aliphatic alcohol is a straight or branched chain C1-C8 alcohol, selected from methanol, ethanol, propanol, butanol, pentanol, hexanol, heptanol and octanol, and most preferably, ester alcohols, e.g., 2,2,4-trimethyl-1,3-pentanediol monoisobutyrate (tradename, TEXANOL). The alcohol may be present in BCAS at a concentration up to about 40% by weight. More preferably, the alcohol is present up to about 20% by weight. Most preferably, the alcohol is present at between about 1-15% by weight.

The preferred acid is a mineral acid, including but not limited to, perchloric acid, hydrochloric acid, phosphoric acid, hydroiodic acid, hydrobromic acid, sulfuric acid and nitric acid. The acid may be present in BCAS at a concentration up to about 30% by weight. More preferably, the acid is present up to about 20% by weight. Most preferably, the acid is present at between about 1-5% by weight.

The ammonium base may be any ammonium-containing basic compound, e.g., ammonium hydroxide. The ammonium base may be present in BCAS at a concentration up to about 40% by weight. More preferably, the ammonium base is present up to about 25% by weight. Most preferably, the ammonium base is present at about 20% by weight.

Where employed, the optional urea may be present in BCAS at a concentration of about 0-25% by weight. More preferably, urea may be present at about 0-15% by weight. Most preferably, urea may be present from about 0-10% by weight.

The optional antifungal and/or insecticidal agent(s) may be any suitable agent which does not substantially affect the ability of BCAS to preserve the treated wood products. Examples of suitable insecticides and fungicides include, but are not limited to, DOWCIL-75 (available from Dow Chemical Company, Midland, Mich.); parabens, such as methyl paraben and propyl paraben; disodium cyanodithioimidocarbonate; methylene bis thiocyanate; isothiazolin; glutaraldehyde; dithiocarbamates; quaternary ammonium compounds; dibromonitrilopropionamide; dibromo dicyano butane; dodecylguanidine hydrochloride; organophosphate compounds, such as malathion, ethl-parathion and diazinon; organosulfur insecticides, such as tetradifon, propargite, and ovex, carbamate compounds, such as carbaryl, methomyl, carbofuran, aldicarb, oxamyl, thiodicarb, methiocarb, propoxur, bendiocarb, carbosulfam, aldoxycarb, 3-iodo-2-propynyl butyl carbamate, promecarb, and fenoxycarb; formamidine insecticides, such as amitraz; dinitropheol compounds, such as 2,4-dinitrophenol; organotin insecticides, such as cyhexatin; pyrethroid compounds, such as allethrin, tetramethrin, fenvalerate, acrinathrin, and permethrin; nicotinoid compounds, such as 1-(6-chloro-3-pyridin-3-ylmethyl)-n-nitro-imidazolidin-2-ylidenamine, phenol compounds, such as 2-phenylphenol and mixtures thereof.

Where employed, the optional fungicide and/or insecticide may be present in BCAS at a concentration of between about 0-30% by weight. More preferably, the fungicide and/or insecticide may each be present independently at concentrations ranging between about 0-20%. Most preferably, the optional fungicide and/or insecticide may present independently at concentrations from about 0-10% by weight.

In preferred embodiments, BCAS comprises:
metallic borate (5-15% by weight)
methyl donor (about 5% by weight)
alcohol (1-15% by weight)
acid (1-5% by weight)
ammonium base (about 20% by weight)
urea (0-10% by weight)
fungicide and/or insecticide (0-10% by weight)
water (20-68% by weight)

In one preferred embodiment of the present invention a wash and/or aqueous treatment is disclosed, wherein conventional wash formulations may be supplemented with BCAS. In some cases, BCAS may be used without further dilution, e.g., as a wash, an additive (to primers, sealants, paints, etc.), and/or a remedial or preventative treatment. In other cases, it may be preferred to dilute the BCAS with water. For example, in preferred embodiments of a wash and/or treatment solution, or an additive to coating formulations, BCAS may be diluted from about 10 parts BCAS to 1 part water, to about 1 part BCAS to 5 parts water. More preferably, the BCAS may be diluted from about 5 parts BCAS to 1 part water, to about 1 part BCAS to about 3 parts water. Most preferably, the BCAS may be diluted by about 3 parts BCAS to about 1 part water.

In another preferred embodiment of the present invention a primer is disclosed, wherein conventional primer formulations are supplemented with BCAS. The BCAS may be added in an amount up to 30% by weight. More preferably, the BCAS may be added in an amount up to 10% by weight.

In another preferred embodiment of the present invention a sealant is disclosed, wherein conventional sealant formulations are supplemented with BCAS. The BCAS may be added in an amount up to 45% by weight. More preferably, the BCAS may be added in an amount up to 35% by weight, and most preferably, in an amount from about 15-33% by weight.

In another preferred embodiment of the present invention a paint is disclosed, wherein conventional paint formulations are supplemented with BCAS. The BCAS may be added in an amount up to 30% by weight, more preferably, up to 35% by weight, and most preferably, between about 4-15% by weight.

Additives to Enhance BCAS Functionality

In some cases, the various components of the treatment solution may not be compatible with each other or the generally water-based carrier solvent of BCAS. Compatibility is the ability of specified components to form homogeneous (one-phase) mixtures. When such is the case, one or more coupling agents may be added to the formulation. Coupling agents generally include co-solvents, surfactants, or other wetting agents that improve the compatibility of various formulation components with the carrier solvent. For example, a coupling solvent may be an active solvent for a resin component to be dissolved in the carrier solvent. Coupling agents increase the limit of dilution of hydrophilic resins with water and may improve treatment solution performance due to better compatibility of various combinations of treatment solution components. Examples of coupling agents that may be used in the present preferred embodiments of the present invention include, but are not limited to, glycol ethers, such as ethylene glycol monoalkyl ethers, diethylene glycol monoalkyl ethers, and propylene glycol monoalkyl ethers (available from Eastman Chemical Company, Kingsport, Tenn.); linear or branched C₁-C₁₂ alcohols; linear or branched C₁-C₁₂ acetates; alkali salts of alkyl, aryl, or alkylaryl sulfonates, such as the sodium or ammonium salts of xylene sulfonate or naphthalene sulfonate; modified alkylaryl polyether surfactants, such as TRITON CF-10 90%; betaine surfactants, such as fatty amidoalkyl betaines; fatty acids; ketones, such as acetone, methylethylketone, methyl isobutyl ketone and D-limonene; and the like, as well as mixtures thereof.

One or more coupling agents may be present in preferred formulations in amounts ranging from about 0-30% by weight. More preferably, a coupling agent is present in an amount of between about 0-15% by weight. Most preferably, the coupling agent is present at a concentration or between about 0-10% by weight.

Suitable sealant compositions may be used in accordance with preferred aspects of the present invention to retard or prevent the wood preserving components of the BCAS from being leached or otherwise removed from the treated wood due to exposure to environmental water or moisture. Suitable sealant compositions include, but are not limited to, wax or paraffin-based materials, polymer-based materials, or mixtures thereof.

Suitable wax or paraffin-based sealant compositions include, but are not limited to, paraffin wax dispersed in mineral oil, such as is disclosed in U.S. Pat. No. 5,342,436 to Thrasher, and wax in the form of micronized particles as disclosed by U.S. Pat. No. 5,017,222 to Cifuentes et al., both of which are herein incorporated by reference.

Suitable polymer based sealant compositions include, but are not limited to, a mixture of a cyclodimethylsiloxane fluid and a polydiorganosiloxane-polyoxyalkylene copolymer, such as those disclosed in U.S. Pat. No. 4,218,250 to Kasprzak; oxyalkalene polymers, such as those disclosed in U.S. Pat. Nos. 5,506,001 and 5,460,751 to Ma et al.; pyridine containing polymers, such as those disclosed by U.S. Pat. No. 4,420,542 to Sowers; amine modified polybutadienes, such as those disclosed in U.S. Pat. No. 4,269,626 to Gorke et al.; vinyl polymer latexes, such as those disclosed in U.S. Pat. Nos. 4,011,090 and 3,945,834 to Clarke et al.; and styrene butadiene copolymers, such as hydrogenated styrene butadiene copolymers, non-limiting examples of which are disclosed in U.S. Pat. No. 5,777,043, thermosetting styrene butadiene copolymers, non-limiting examples of which are disclosed in U.S. Pat. No. 5,017,653 to Johnston, and a styrene-butadiene rubber (SBR) latex, which may be the product of a polymerization carried out in an emulsion system where a mixture of at least two monomers (styrene and butadiene) is mixed with an aqueous soap (or other surface active agent) solution containing the necessary polymerization initiators as is well known in the art. The final product may be an oil-in-water emulsion of the resulting copolymer, e.g., a fluid latex. Examples of commercially available SBR latexes that may be used in accordance with aspects of the present invention include, but are not limited to the SYNTHOMER styrene butadiene latexes available from Synthomer Limited, Harlow, Essex, United Kingdom and the CP Modified S/B Latexes, the DL Modified S/B Latexes, the FC Modified S/B Latexes, the PB Modified S/B Latexes, the CT Modified S/B Latexes, the HS Hollow Sphere Plastic Pigment Latexes, the A Solid Plastic Pigment Latexes, the HS Solid Plastic Pigment Latexes and the PB Solid Plastic Pigment Latexes available from Dow Chemical Co., Midland, Mich. All of the patents recited above are incorporated herein in their entirety by reference thereto.

Examples of sealant compositions that are mixtures of wax or paraffin-based sealants and polymer-based sealants include, but are not limited to, mixtures of the abovementioned wax or paraffin-based sealant compositions and polymer-based sealant compositions, mixtures of a styrene block copolymer, styrene-butadiene copolymer, a moisture-curable silylated polyurethane prepolymer, an aromatic tackifier resin, a polar tackifier resin, a polyethylene wax, and an organo silane adhesion promoter as disclosed in U.S. Pat. No. 6,121,354 to Chronister, and a water-based polymeric binder and a wax hydrophobic filler as disclosed in U.S. Pat. No. 4,897,291 to Kim. A non-limiting example of suitable wax or paraffin-based sealant compositions are those available from Michelman, Inc., Cincinnati, Ohio, such as Michem®-Wood Coat 50. All of the patents recited above are incorporated herein in their entirety by reference thereto.

In some embodiments a sealant composition is present at a level of at least 0.1 percent by weight, often at least 0.25 percent by weight, typically at least 0.5 percent by weight, and in some cases at least 1.0 percent by weight. When the level of sealant composition is too low, the wood treating materials in the treated wood may be leached out or removed by environmental water and moisture. The sealant composition may be present at a level of up to 20 percent by weight, often up to 16 percent by weight, typically up to 12 percent by weight, and in some cases up to 10 percent by weight. When the level of sealant material is too high, the solution, paint, primer, wash, etc. may be too viscous to be applied properly and may not have the required ability to penetrate the wood. The sealant composition may be present in any range of values inclusive of those stated above.

When a rheology modifier is included in any of the solutions or foams, it is included at concentrations ranging from about 0.01% to about 5% by weight. Minimum levels are usually at least 0.01 percent by weight, often at least 0.1 percent by weight, typically at least 0.15 percent by weight, and in some cases at least 0.2 percent by weight. When the level of rheology modifier is too low, the solution may not have an optimum flow profile and resulting in not enough solution penetrating the wood. The rheology modifier is present in the solution at a maximum concentration of up to 5 percent by weight, often up to 4 percent by weight, typically up to 3 percent by weight, and in some cases only up to about 2 percent by weight. When the level of rheology modifier is too high, the solution may be too viscous to be applied properly and may not have the required ability to penetrate the wood. The rheology modifier may be present in the solution in any range of values inclusive of those stated above.

Examples of suitable rheology modifiers include, but are not limited to, thickening agents including cellulosic agents, such as hydroxymethyl cellulose, lignum, and carboxymethyl cellulose; acrylic thickeners, such as alkali swellable latexes; urethane thickeners; natural gums, such as xanthan and guar; byproducts from the manufacture of paper, such as lignum, lignin, cuminol, and culmonol; and acrylamide-based thickeners. Preferred thickening agents are hydroxymethyl cellulose (e.g., CELLOSIZE ER-15000M) and alkali swellable latexes.

As used herein and in the claims, the term “lignum” refers to polymers and tissues found in wood, which may be isolated, for example, during wood chipping, wood pulping, and other such operations performed in the manufacture of paper and paper products.

As used herein and in the claims, the term “lignin” refers to any of the complex polymers that are deposited within the cellulose of a plant cell, as well as derivatives thereof, that tend to act as a natural glue by tying together cellulose fibers, making the plant rigid, which have been subsequently removed and isolated from the plant, and impart changes in the rheological properties of solutions that they have been added to. Examples of lignin and modified lignin include, but are not limited to those available under the trade names KRAFTSPERSE, REAX, POLYFON and INDULIN from MeadWestvaco Corporation, Charleston, S.C.

As used herein and in the claims, the term “culmonol” refers to natural substances occurring in various plants and trees which may be isolated, for example, during wood chipping, wood pulping, and other such operations performed in the manufacture of paper and paper products.

As used herein and in the claims, the term “wetting agent” refers to a material, that when added to a liquid, increases the liquid's ability to penetrate or spread over the surface of a given substrate.

When a wetting agent is included in the BCAS, it may be included at a level of at least 0.1 percent by weight, typically at least 0.15 percent by weight, and in some cases at least 0.2 percent by weight. When the level of wetting agent in the solution is too low, the solution may not adequately penetrate into the wood during treatment. The wetting agent is present in the solution at a level of up to 10 percent by weight, often up to 5 percent by weight, typically up to 4 percent by weight, and in some cases up to 2 percent by weight. When the wetting agent is too high, the solution may tend to foam during treatment, which may create operational problems on a commercial scale. The wetting agent may be present in the boron-containing aqueous solution in any range of values inclusive of those stated above. Any suitable wetting agent may be used. Examples of suitable wetting agents include, but are not limited to, silicates, such as metasodium silicate; anionic surfactants, such as sodium dodecyl sulfate and sodium lauryl sulfate; cationic surfactants; amphoteric surfactants; zwitterionic surfactants; and phosphates, such as trisodium phosphate and tetrasodium pyrophosphate.

The preferred BCAS may include any other desirable additive(s), such as a suitable dye or staining agent.

Methods of Treating and/or Preventing Damage to Wood or Wood Products

BCAS can be applied as a solution or foam for wood treatment against wood destroying organisms and as a crack and crevice treatment for general insect control. When applied as a solution or foam to wood, BCAS will penetrate into the wood to various depths dependent on the moisture in the wood and the wood species. Because preferred borates do not break down, as normal moisture changes occur in the wood, they are available to be drawn deeper into the wood over time, providing long-lasting protection.

When BCAS is used as a foam, one or more surfactants and/or foaming agents may be added. The surfactants and/or foaming agents include conventional surfactants having a foaming property. Accordingly, any suitable foaming agent(s) known to those skilled in the art can be used for purposes of this embodiment.

The preferred BCAS is a unique product for the protection and/or remedial treatment of wood against many wood destroying organisms, and/or as a general pest control composition. Applicant has found that the protective and/or remedial actions of BCAS may be optimized for particular organisms or indications by varying the application modes and methods, as detailed in Table 1.

TABLE 1

| Organism/application | Application method (spray or foam) |
|---|---|
| Fungi | One application. For serious infections, 2 applications, 1-24 hours |
| | apart or inject at source. |
| Beetles | One application. All accessible bare wood surfaces are preferably |
| | treated. |
| Subterranean termites | For remedial use, 2 applications, 1-24 hours apart. When accessible, |
| | drill and inject solution and foam directly into wood where galleries |
| | are detected. |
| Formosan subterranean | 2 applications, 6-24 hours apart. When accessible, drill and inject |
| termites | solution and foam directly into wood where galleries are detected. |
| Drywood termites | For remedial use, 2 applications, 1-24 hours apart. When accessible, |
| | drill and inject solution and foam directly into wood where galleries |
| | are detected and spray or foam all accessible wood surfaces. |
| Carpenter ants | One application to wood will prevent nesting. Excavations can be |
| | sprayed. |
| General pests | 2 applications, 1-2 hours apart, preferably as a crack and crevice |
| (cockroaches, ants, | treatment. |
| silverfish, earwigs etc.) | |
| Preventative treatment | 2 applications, 1 hour to 1 year apart. This treatment against wood |
| | destroying organisms is intended only as part of an ongoing |
| | preventative maintenance and inspection program. |
| New construction | 2 applications, 1-2 hours apart. All accessible bare wood surfaces are |
| | preferably sprayed after framing and roofing are in place. |
| Siding, trim, logs | 2 applications, 1-2 hours apart. All accessible bare wood surfaces are |
| | preferably sprayed. Wood is preferably sealed after treatment is dry. |
| Decks | 2 applications, 1-2 hours apart. Remove any dirt, debris or sealants on |
| | surface. All accessible bare wood surfaces are preferably sprayed. |
| | Wood is preferably sealed after treatment is dry. |

In a crack and crevice treatment, fine particles deposited when the product dries out adhere to the body of an insect as it crawls over the treated area. The active ingredients, including the borate and/or optional insecticidal or antifungal agents, are ingested through the insects' normal grooming habits.

The mode of action for BCAS is that of a slow acting stomach poison to insects. As wood destroying organisms or their larvae feed on, tunnel in and/or digest wood, they accumulate the active ingredients into their systems.

Since BCAS is slow acting, termites that have fed on treated wood can accumulate the active ingredients and still move among other individuals in the colony. As workers feed nymphs, soldiers and reproductives, this transfers the ingested active ingredients throughout the colony. Affected individuals also exhibit behavioral changes. They become sluggish, stop feeding and eventually become moribund. Others in the colony will avoid these individuals as well as areas where these individuals have died. Accordingly, the treated wood is not the first choice for feeding, and therefore the treated wood is avoided by foraging termites.

Wood treated with the preferred BCAS also deters wood destroying beetle larvae. Eggs deposited on the surface of treated wood by beetles will have a reduced hatch rate. Larvae that may hatch from eggs will soon die after attempting to eat into treated wood. In infested wood, the larvae will die from ingesting treated wood as they tunnel toward the surface of the wood to pupate. Depending on the life cycle of the beetle, type of beetle, and seasonality of treatment, adult beetles may emerge, but will not re-infest the wood.

Carpenter ants do not feed on wood but they cause substantial and rapid damage by excavating cavities in wood for nesting. Wood treated in accordance with the preferred aspects of the present invention becomes unpalatable to carpenter ants and is not excavated. However, treated wood alone may not prevent a carpenter ant infestation since the ants can penetrate construction features and avoid chewing treated wood. Regular inspection is recommended and further treatments to infestation sites will deter the carpenter ants from nesting.

Fungi can infect and rapidly destroy wood where there are moisture problems. Some fungi can actively transport moisture from the ground or a leak to wood of lower moisture content in efforts to expand the colonization of the wood. The boron active ingredient is highly toxic to decay fungi and will kill the fungi present and protect against future infections.

The preferred BCAS is also active against other general pests such as cockroaches, ants, silverfish, earwigs and crickets, preferably by a crack and crevice treatment with BCAS in either solution or foam states.

Application of BCAS to control wood destroying organisms is preferably part of an Integrated Pest Management (IPM) Strategy. Problems that may have led to the infestation or that may do so in the future are preferably corrected. This includes correcting moisture leaks, providing adequate ventilation and moisture barriers and removal of debris from crawl spaces. After the initial treatment, inspections are desirable on a regular basis and additional preventative treatments with products containing BCAS can be made (e.g., primers, paints, stains, etc.). Each additional treatment will increase the borate loading and penetration into the wood, further protecting it from insect attack.

The amount of BCAS needed can vary greatly depending on the application. As a initial guideline, 1 gallon of BCAS should treat about 200 square feet of wood surface area, although as those skilled in the art will appreciate, coverage will vary greatly depending on the material, temperature during application, and other ingredients, (e.g., viscosity enhancers, paint ingredients, etc.). Further, coverage will vary depending on the physical state (solution or foam).

When preparing foam, typically 1-2 ounces of foaming agent is added to the solution to produce dry foam with the desired expansion ratio of approximately 20 to 1 (approximately 20 gallons of foam per 1 gallon of aqueous solution). The foam should be of the consistency that adheres to wood surfaces, so that run-off is minimized. Since each foam machine can produce different foams, refer to the equipment manufacturer manuals and the foaming agent's label for specific instructions.

BCAS (solution or foam) can be applied as a spray. BCAS is preferably applied evenly to wood preferably using a medium to coarse spray at low pressures, preferably at 20-30 pounds per square inch (psi). Low-pressure application should reduce drips, off-target spray and result in proper amounts of active ingredient on the surface.

Application rate is preferably 1 gallon per 200 square feet of wood surface area. It is preferable that all accessible wood surfaces are thoroughly wetted. Wood will absorb BCAS at different rates. Surfaces that absorb solution rapidly are preferably re-sprayed immediately.

Pressure injection can also be used to apply BCAS into both infested and uninfested woods. Preferably, the wood is drilled and the BCAS is injected until the solution or foam runs out of openings, damaged areas or kick-holes in the wood. It is preferable that wood greater than four inches thick be both injected and sprayed.

BCAS (solution or foam) can be injected into infested wood. Preferably, each hole is injected with BCAS until runoff is observed from other holes, galleries, kick-holes, etc. When injecting solid wood, preferably maintain the injection pressure for 15 to 60 seconds at each hole. More preferably, maintain the injection pressure for longer than 60 seconds.

BCAS can also be injected into uninfested wood including, but not limited to, wood adjacent to the infested areas. It is preferable that this procedure be used for painted or sealed wood. It is preferable that the sprayer or application equipment be able to maintain 60-75 pounds of pressure.

Injection tips are preferably stainless steel and fit snugly into the drilled hole to prevent drippage or sprayback. Preferably, a short injection tip, such as a 1 inch tip, is used. This will allow the solution to flow into the drilled wood.

BCAS can also be applied as a foam directly to wood surfaces. For example, the BCAS foam can be injected into infested galleries, applied to joints and injected into void areas such as studded and block walls. It is preferable that the BCAS foam be of a consistency that adheres to the wood surface, which should minimize run-off. It is preferable to apply the BCAS foam between wood joints or abutting wood surfaces. When applying the BCAS foam in wall voids, it is preferable to inject enough foam to contact the wood surfaces of the studs in the wall or target area desired. When using the BCAS foam to inject into galleries, it is preferable to pressure inject the foam.

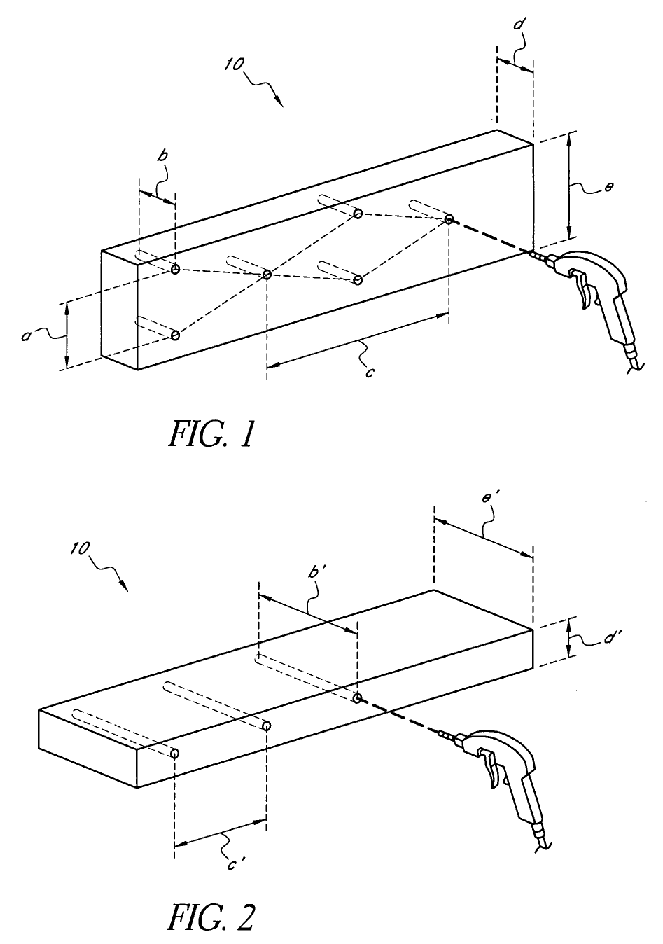

With reference to FIG. 1, according to one preferred embodiment of the treatment regimen, it is preferred to drill into the wood, preferably in the area of suspected infestation, preferably making injection holes 7/64 to 1/8 inch in diameter. The holes are preferably drilled in a pattern (e.g., a diamond pattern) with a long axis along the grain and the holes preferably spaced every 12 to 16 inches. It is preferable for the holes to be spaced approximately 4 to 6 inches across the grain. It is preferable that the wood is treated about one diamond length pattern beyond the immediate area of visible infestation.

It is preferable to drill the holes through the widest dimension available, preferably drilling through approximately three quarters of the width of the beam. With reference to FIG. 2, if the widest surface is not accessible, holes can be drilled in the narrower surface. It is preferred to drill holes approximately 8-10 inches apart.

Treatment is preferably conducted at temperatures above 0° F., and more preferably, above 32° F. Good results and penetration will be obtained with temperatures above 40° F. Most preferably, the temperatures are above about 55° F. Wood does not take up aqueous solutions as readily at lower temperatures.

Occasionally, BCAS may drip or run onto glass surfaces such as windows and doors. After drying, a white residue may appear. This can be removed with warm water and a mild soap solution.

Heartwood is more difficult to penetrate with water-based solutions as compared to sapwood. Logs may have knots in them that consist predominantly of heartwood. A white residue may remain in these areas after applying BCAS. This can be removed with a damp cloth.

In preferred embodiments, the invention is particularly advantageous because BCAS will generally not corrode metals normally used in construction. Such metals include ferrous metals, galvanized metals, screws and nails. In addition, BCAS will generally not affect electrical wiring, but it is preferably that applications to wood be performed before wiring is in place.

Other advantages of the preferred BCAS formulations is that they will not discolor most wood and are compatible with most paints and sealants.

Fungi, mildews, mold and wood rots are the result of either high moisture present in the wood (wood rots) or lack of adequate air circulation (ventilation) in the case of mildews and molds. A ‘mustiness’ or damp odor may be associated with these conditions. When BCAS is applied, the increased moisture may temporarily enhance this odor, until the wood dries out.

When mildew and mold fungi are present, the spraying of areas where there is active growth of the fungi may cause some spores of the fungi to become airborne. Mold spores can cause reactions in people allergic to these organisms. To reduce spores, it is preferable to apply BCAS at 65 to 70 pounds of pressure. Alternatively, paint containing the preferred boron-containing aqueous solution can be applied to areas of active growth to reduce the possibility of airborne spores. In another embodiment, the site(s) of active growth may be treated with a bleach and water mixture prior to the application of the preferred BCAS.

Preferably, BCAS is applied to bare, unsealed wood, plywood (and all other engineered wood products) and other cellulose materials where a intact water repellent barrier such as paint, stain or a sealer is not present. Preferably, dirt, mold, debris and any existing water repellent finish is removed to allow absorption of the BCAS into the wood. Preferably, the wood is allowed to dry before applying the BCAS. Treated wood can be machined, shaped, painted and glued.

In one embodiment, basement and crawlspace structures can be treated by applying BCAS (solution or foam) on all bare wood accessible in the flooring and sub-flooring. This application will control an infestation even when certain parts of a gallery are not directly sprayed.

In one embodiment, attics can be treated by applying BCAS (solution or foam) to all accessible wood, including, but not limited to, rafters, trusses, top-plates, ceiling joints, plywood, particle board, etc. More preferably, accessible areas with known infestations should be drilled and injected with the BCAS (solution or foam).

In another embodiment, exterior wood can be treated by applying BCAS (solution or foam) to bare siding, trim or logs. Applications can be made by spray or pressure injection techniques. Preferably, painted or sealed wood can be treated by pressure injection, or the sealing coat can be removed prior to application. Following treatment, the exterior wood can be preferably sealed to prevent the BCAS (solution or foam) from diffusing out. Applicable sealing coats include, but are not limited to, paints, varnishes, stains and waterproofing treatments. Preferably, wood is dry before applying a sealing coat. More preferably, the sealing coat is not applied until at least 48 hours after applying BCAS (solution or foam).

In another embodiment, decks can be treated with BCAS (solution or foam). The deck may be prepared by removing any dirt, debris or sealants that will interfere with the application and absorption of the BCAS (solution or foam). After the deck has dried, preferably dry to the touch without standing puddles, one application of BCAS (solution or foam) can then be applied to the wood. Preferably, following treatment, the deck is sealed to prevent the BCAS (solution or foam) from diffusing out. Applicable sealing coats include, but are not limited to, paints, stains, varnishes and waterproof sealing. Preferably, wood is dry before applying a sealing coat.

In another embodiment, wood in new construction can be pretreated with BCAS. The preferred BCAS (solution or foam) can be applied to any accessible bare wood surfaces including, but not limited to, flooring, sub-flooring, sill plates, top plates, wall studs, trusses, rafters, roofing plywood, etc. Preferably, application of the BCAS (solution or foam) is performed after framing and roofing are in place and before insulation and drywall are installed. Treated wood is preferably protected from excessive rain.

In another embodiment, food handling areas can be treated with BCAS. Preferably, the BCAS (solution or foam) is applied to cracks and crevices in food handling areas of food handling establishments. More preferably, the preferred solution or foam is applied between different elements of construction, for example, between equipment and floors, hollow spaces in walls and equipment legs and bases where insects may hide.

In some embodiments, the BCAS (solution or foam) is applied to wood as one application. In others, the BCAS (solution or foam) is applied using two applications. Calculating the amount of BCAS to be used for a particular treatment may be performed in accordance with a preferred embodiment with reference to the following guidelines. Approximately 1 gallon of the BCAS (solution or foam) will be needed to treat 200 ft² of wood surface area. This general guideline amount of BCAS (solution or foam) needed may be adjusted up or down depending on a number of factors, including, the total square footage of wood to be treated, the state of the BCAS (e.g., solution or foam), the application method (e.g., spraying or injecting), and the ambient conditions (e.g., humidity, wood moisture level, temperature, surface pre-treatments, etc.).

For some embodiments, there are some predetermined factors which can be used as multipliers for given situations to calculate the square footage of wood to be treated. For example, for a piece of wood that was 10 feet long and 6 inches wide, one side of the piece of wood will be 5 ft² of wood surface area (10 ft.×0.5 ft.=5 ft²). Applying BCAS (solution or foam) to all four sides with a total square footage of 20 ft² would require about 0.1 gallons for one application (1 gallon treats 200 ft²). A second application would require another 0.1 gallon, preferably after a suitable waiting (drying) time.

When calculating square footage of wood surface area in a crawl space or basement, one will preferably consider all the wood present. Preferably, the square footage of the crawl space is determined by first multiplying the length by the width, i.e., a 20 ft.×40 ft. crawl space is 800 ft². Next, this is multiplied by 2.5 and the result is an approximation of the total square footage of wood surface area for all the wood in the crawl space. Therefore, a 20 ft.×40 ft. crawl area would consist of 2,000 ft² of wood surface area (20×40×2.5). Dividing the total square footage (2,000 ft²) by square footage treated by 1 gallon (200 ft²) results in approximately 10 gallons of BCAS for one application.

In estimating the amount of BCAS needed for a treatment of the entire structure, there are many sections to consider, including, but not limited to, attics, interior walls, exterior walls and flooring. The guideline to use here is to obtain the square footage for the living area of the structure from the builder and multiply by 9. If a crawl space or basement is involved, then use the calculations above and add that number to the amounts calculated here. For example, if the structure to be treated is 2,000 ft² and has a 20 ft.×40 ft. crawl space then the wood surface area is 2,000 multiplied by 9, equaling 18,000 ft². Add the 2,000 ft² (calculated above) for the crawl space to get 20,000 ft² of wood surface to be treated. Dividing by 200 ft² per gallon, yield an amount of 100 gallons of BCAS per application.

For general pest control the BCAS (solution or foam) may be limited to crack and crevice treatments only.

The preferred BCAS disclosed herein above is an effective treatment for wood against decay fungi, including, but not limited to brown (i.e. Poria), white, and wet rots and wood-boring insects such as but not limited to the following termites, beetles and carpenter ants. For example, Subterranean Termites, include Heterotermes, Reticulitermes, and Coptotermes (Formosan); Drywood Termites, include Kalotermes and Incisitermes; Dampwood Termites include Zootermopsis; Carpenter Ants include Camponotus; “False” PowderPost Beetles include Bostrichidae; Furniture and Deathwatch Beetles include Anobiidae; Old House Borers include Longhorn beetles and Cerambycidae; and Ambrosia Beetles include Scolytidae

In one embodiment, the preferred BCAS can be used for wood and cellulose materials, in accordance with the specific treatment methods described herein. Preferably, this product should be applied only to treat bare wood, plywood and particle.

The preferred BCAS can be used on all interior and exterior wood that is preferably protected from excessive rain and not in direct contact with soil. Types of wood include, but are not limited to, all types of lumber, logs and plywood.

In one embodiment, the preferred BCAS (solution or foam) is used for remedial control of organisms attacking wood, or for protection of wood against future infestations, using 2 applications of the solution or foam.

In another embodiment, BCAS is applied by brush until the wood surface is thoroughly wet, preferably at a rate of approximately 1 gallon per 200 square feet of wood surface area.

In another embodiment, the preferred BCAS is applied by spray until the wood surface is thoroughly wet, at a rate of approximately 1 gallon per 200 square feet of wood surface area. The spray is preferably applied evenly using a medium or coarse spray at low pressure, preferably 20-30 psi. Preferably application is when ambient temperatures are above 55° F.

In one embodiment, a BCAS foam is applied so that all accessible wood surfaces are covered with foam at a rate of approximately 1 gallon per 200 square feet of wood surface area. The spray should be applied evenly using preferably a medium or coarse spray at low pressure, preferably 20-30 psi. Preferably, the BCAS foam is applied between wood joints or abutting wood surfaces. In wall voids, it is preferable to inject enough of the foam to contact wood surfaces of studs in the wall or the target area desired. Preferably application is when ambient temperatures are above 55° F.

In one embodiment, the BCAS (solution or foam) is used remedially to treat established infestations of termites and/or carpenter ants. The BCAS is preferably injected down to 1 inch, more preferable ½ inch, below the surface.

Manufacturing Commercial Wood Products Comprising BCAS

A method of treating materials in accordance with the present invention includes pressure treating wood products with a treatment solution comprising BCAS. Such methods are useful for treating dried and/or engineered wood products and/or green lumber.

The pressure treating method may include for example, the following steps: placing the material in a pressure vessel and optionally applying a vacuum; contacting the material with BCAS; increasing the pressure in the pressure vessel; draining the solution and optionally reducing the pressure by applying a vacuum; and drying the treated wood product through the application of energy. The application of pressure, followed by the application of a vacuum, may be repeated, as desired, to increase the penetration of the BCAS into the wood.

In an alternative method, wood particles are slurried in BCAS further comprising a glue. The slurry is injected into a press, for instance, a steam press, and the slurry is pressed to form a board or other engineered wood product. The engineered wood product can be fiberboard, particleboard, or oriented strand board. The wood product is then cured. As a further alternative, BCAS and/or other additives can be injected directly into the press prior to pressing and curing.

The application of energy includes the use of radiant heat, electrical current, microwaves, lasers, convection ovens, dehydration, spot heating to high temperatures for short periods of time, and the like.

BCAS may be applied by pressure treating, soaking, spraying, painting, washing, dipping, rubbing, mixing, blending, infusion, and the like, as well as any combination of such methods.

In order to treat materials, e.g., wood products, in accordance with preferred aspects of the present invention, the wood product may be placed in a pressure vessel. The door of the pressure vessel is closed, and optionally, a vacuum is applied to the pressure vessel. When the vacuum is applied, the pressure in the pressure vessel is reduced to less than 750 mm Hg, in many cases to less than 500 mm Hg, typically to less than 300 mm Hg, and in some cases to less than 200 mm Hg. If the pressure is too high when the vacuum is applied, the BCAS may not adequately penetrate into the interior of the wood cells. When the vacuum is applied, the pressure in the pressure vessel is at least 1 mm Hg, in many cases at least 10 mm Hg, typically to at least 20 mm Hg, and in some cases at least 30 mm Hg. The pressure is limited based on the rating of the pressure vessel. Further, when the pressure is too low, excessive foaming of the solution may result. When a vacuum is applied, the pressure in the pressure vessel may be any range of values inclusive of those stated above.

When the pressure vessel is pressurized, the pressure will be at least 10 pounds per square inch (psi), in many cases at least 20 psi, typically at least 30 psi, and in some cases at least 40 psi greater than atmospheric pressure. When the pressure in the pressure vessel is too low, the BCAS may not adequately penetrate into the wood. When the pressure vessel is pressurized, the pressure can be up to 500 pounds per square inch (psi), in many cases up to 300 psi, typically up to 250 psi, and in some cases up to 200 psi greater than atmospheric pressure. The upper limit of pressure is typically limited by the pressure rating of the pressure vessel. In an embodiment of the present invention, the pressure of the pressure vessel is 40 to 160 psi in excess of atmospheric pressure when applied to the wood products. In another embodiment of the present invention, a pressure of 40 psi is applied when particleboard, MDF, and OSB are treated using the present method. In a further embodiment of the present invention, a pressure of 140 psi is applied when natural wood products are treated using the present method.

During pressure treatment, the BCAS may be circulated under pressure for between twenty and ninety minutes. Wood products are typically treated for thirty minutes. Particleboard, MDF, OSB, and natural wood products are treated for thirty to ninety minutes. After treatment, the chamber is drained and optionally, a vacuum, as described above, may be applied for five to twenty minutes. The chamber is then opened, and the treated wood product is removed.

The final step may involve the application of energy to the treated wood. In an embodiment of the present invention, the treated wood product is either placed in a drying kiln and slow-dried for twenty-four hours with hot air and steam, air dried for ten days, or microwave dried for up to eight hours.

The BCAS can also be used in a variety of methods commonly used for preparation of “engineered” wood products, such as, without limitation, particleboard, fiberboard, and oriented strand board. These wood products are generally prepared by forming a slurry of wood fibers or particles and an appropriate glue. The slurry is placed in a steam press, forming the wood product. The wood product is subsequently cured. According to one embodiment of the present invention, the cured wood product is pressure treated in the presence of the BCAS, as described above.

The wood product can also be treated with BCAS at an earlier stage. In one version of the method of the present invention, the BCAS and any additional additives (e.g., additional insecticides and/or urea) are mixed into the slurry of wood fibers or particles and glue, prior to placing the slurry into the steam press. Alternatively, the BCAS and additives are added to the press after the slurry is placed into the press. The superior penetrating and preservation activity of BCAS allows the addition of the solution and/or any further additives at any time during the preparation of the engineered wood product, or afterward, so long as the addition of the BCAS is physically possible.

Whole House Concept (“WHC”)

One preferred model for providing protection against wood destroying organisms and toxic molds as well as damage caused by fire in residential construction is termed herein, the “Whole House Concept (WHC)”. The WHC involves painting the inside and outside of the house with a coating that controls flame-spread and treating and/or pre-treating all framing wood and doors throughout the house. Solid wood for framing elements such as sills, studs and roof trusses, and engineered wood composite such as oriented strand board (OSB) for structural panels, and medium density fiberboard (MDF) for door cores and flooring, are preferably pre-treated during the manufacturing process, e.g., by pressure treating, slurrying, soaking, spraying, painting, washing, dipping, rubbing, mixing, blending, infusion, and the like, as well as any combination of such methods, as detailed above. Preferred elements of the WHC include inter alia suitable treatments for the framing lumber, a supply of engineered wood composites, and treated door cores.

The preferred BCAS can be used to manufacture products (e.g., paints and coatings) that can be applied to solid wood framing and/or engineered wood products (OSB and MDF), thereby creating a unique line of high quality paints and coatings that have the ability to reduce flame-spread, insect and fungal damage. In preferred embodiments, the framing and/or engineered wood products are pre-treated as described above to maximize loading of the active boron-containing ingredients, as well as active additives.

While the WHC concept is novel, the premise for its market development is well established and supported by market need. In North America, most residential buildings use wood frame structures for the structural skeleton and wood panels for shear strength. In many areas, homes are protected against subterranean termites by treating the soil under homes prior to construction and by treating the soil around existing homes and/or by treating the structure itself when termites are detected. The current generation of termiticides has shown to be much less effective and durable, leading to termite infestations in relatively new structures. Additionally, soil treatments don't protect structures against beetles, aerial nesting of termites and wood decay fungi.

Alternative Formulations and Methods

Attempts have been made by others to minimize the leaching of an ammonium pentaborate active ingredient by adding soluble calcium salts to the sodium sulfate/ammonium pentaborate composition, to obtain a second set of reaction products that is less prone to leaching out of the wood or wood products. However, results with the calcium salts have met with only limited success, as the post-addition of the calcium salts to the sodium sulfate/ammonium pentaborate composition generates insoluble calcium compounds and/or calcium borates, causing those insoluble products to precipitate out of the solution before application. Besides making the application more difficult, the above-described process can remove both calcium and borates from the composition to be applied to the wood, thereby decreasing the effectiveness of the composition. In order to avoid this condition a second set of reaction conditions would be required (secondary application to treated wood), thereby necessitating an additional treatment step to produce the desired products.

Calcium borate ores have previously been used as components in dry powder flame-retardant formulations. One such use was described in U.S. Pat. No. 3,865,760, to Pitts, et al. (incorporated herein in its entirety by reference thereto), wherein the ore colemanite (or alternatively, the ores ulexite or pandermite) was used as a filler in a rubber and plastic dry powder formulation, alone or in combination with alumina trihydrate and calcium carbonate. In this formulation, high levels of unreacted dry colemanite were required in order to receive the desired flame-retardant effect.

Another such use was described in U.S. Pat. No. 4,076,580 to Panusch, et al. (incorporated herein in its entirety by reference thereto). This patent discloses a process for producing flame-retardant cellulosic board, comprising treating the board with a “synergistically acting” composition consisting of alumina hydrate and ulexite. The combination requires loadings for flame retardation at high levels that sometimes interfered with the board properties.

Another use was described in U.S. Pat. No. 4,126,473 to Sobolev, et al. (incorporated herein in its entirety by reference thereto). This patent discloses a three-component flame-retarding agent consisting of an “aluminous” material, a boron-containing mineral such as colemanite or ulexite, and a “co-synergist”, namely a phosphate or sulfate-containing inorganic salt.

Attempts have also been made to obtain treatment solutions for either flame retardation or for the protection from wood decay fungi, termites and wood-boring insects using water-soluble sodium borates. However, since sodium borates are highly soluble in water, these products have not provided adequate resistance to leaching after the application to wood or wood products.

U.S. Pat. No. 4,873,084 to Sallay (incorporated herein in its entirety by reference thereto) discloses an insecticidal composition utilizing ammonium pentaborate and an anti-mildew agent. This patent discusses the insecticidal activity of ammonium pentaborates. Ammonium pentaborates are precursors to boric acid, which is formed during ingestion by the insect. The patent states that certain calcium and barium triborates act in a similar fashion to produce boric acid in vivo in insects, the boric acid being toxic to insects. In the process described in this patent, wood previously treated with ammonium pentaborate is secondarily treated with various barium and calcium salts to cause a chemical change to a less soluble barium and/or calcium borate product. A mildewcide such as BUSAN® or TROYSAN® (2-iodo-2-propynyl butyl carbamate) is added to control wool-boring insects and wood decay fungi. Another Sallay patent, namely U.S. Pat. No. 4,514,326 (incorporated herein in its entirety by reference thereto), discloses a flame retardant composition comprising ammonium pentaborate, and an alkali and/or alkaline earth metal sulfate, sulfite, hydrophosphate, or mixtures of them. The reaction products are produced by heating an aqueous suspension of a metal tetraborate ore, and then reacting the resulting product with an ammonium salt, such as ammonium sulfate.

### EXAMPLES

### Example 1

### Solution for Use as a Cleaner and Inhibitor of Mold Comprising BCAS

| DESCRIPTION | POUNDS % |
|---|---|
| Diluted BCAS* | 01.00-04.00 |
| TSP (trisodium phosphate) | 00.10-00.80 |
| Boric acid | 08.00-10.00 |
| Liquid soap | 00.01-00.30 |
| Glycerin | 01.00-05.00 |

Mix well, and then add the following while mixing:

| | |
|---|---|
| Diluted BCAS* | 04.00-08.00 |
| Ammonium hydroxide | 05.00-10.00 |
| TROYSAN POLYPHASE P-20T (mildewcide) | 00.01-03.00 |
| BYK-022 silicon defoamer (polysiloxane) | 00.01-00.17 |
| VISCOSITY | 16-18 Sec's ZAHN # 2 |
| | cup |
| pH | 8.5+ |
| COLOR | STD 09F; DE .25 MAX |
| STRAINING | 400M CHEESECLOTH |
| #/GAL | +/−0.2 |

PHYSICAL PROPERTIES

| DESCRIPTION | VALUE | DESCRIPTION | VALUE |
|---|---|---|---|
| TOTAL VEH WT % | 100.000 | TOTAL VEH VOL % | 100.000 |
| PIGMENT WT % | 0.000 | PIGMENT VOL % | 0.000 |
| VOLATILE WT % | 88.813 | VOLATILE VOL % | 88.750 |
| ORG SOLV WT % | 0.731 | ORG SOLV VOL % | 0.751 |
| SOLIDS WT % | 11.187 | SOLIDS VOL % | 11.250 |
| VEH SOLIDS WT % | 11.187 | VEH SOLIDS VOL % | 11.250 |
| DENSITY | 8.430 | SPEC. GRAVITY | 1.068 |
| BULKING FACTOR | 0.112 | P.V.C. % | 0.000 |
| P/B RATIO | 0.000 | SPREAD @ 1 MIL | 180.449 |
| CPSFA @ 1 MIL | 0.0227 | COATING VOC | 64.959 |
| MATERIAL VOC | 7.795 | TIO2 WT % | 0.000 |
| TiO2 WT % PIGMNT | ***** | CaCO3 WT % | 0.000 |
| CaCO3 WT % PIGMT | ***** | SILICATES WT % | 0.000 |
| SILCATE WT % PIG | ***** | OTHER PIGMT WT % | 0.000 |
| OTHR PGM WT % PG | ***** | RESN SOLIDS WT % | 0.000 |
| RESIN WT % VEH | 0.000 | WATER WT % | 59.618 |
| WATER WT % VEH | 59.618 | SOLVENT WT % | 0.731 |
| SOLVENT WT % VEH | 0.731 | ADDITIVES WT % | 39.651 |
| ADDITIV WT % VEH | 39.651 | OPAQUE PLMR WT % | 0.000 |
| WATER VOL % | 0.869 | | |

*Diluted BCAS is a dilution of 3 parts full strength BCAS with 1 part water.

### Example 2

### Flame Retardant Primer that is Resistant to Mold and Insect Infestations

| DESCRIPTION | POUNDS % |
|---|---|
| BCAS | 50.00-70.00 |
| CELLOSIZE ER-15000M (hydroxymethylcellulose) | 01.00-03.00 |

Mix well for 10-15 min until clear, then add:

| | |
|---|---|
| Ethylene glycol | 20.00-40.00 |
| TAMOL 681 (acrylic polymer in propylene glycol) | 10.00-20.00 |
| SURFYNOL 104PG-50 (acetylenic diol) | 01.00-03.00 |
| AMP-95 (2-amino-2-methyl-1-propanol) | 02.00-04.00 |
| RHODOLINE 654 (petroleum hydrocarbon defoamer) | 01.50-06.50 |
| PROXEL DL (preservative: | 00.00-02.00 |
| 1,2-benzisothiazoline-3-one) | |
| Boric acid | 08.00-12.00 |
| KRONOS 2020 (TiO₂) | 90.00-110.00 |
| OMYA 4 \/ VICRON 15 (CaCO₃) | 190.00-212.00 |
| ZINC OXIDE, L.F. #417 (ZnO₂) | 10.00-14.00 |
| BCAS | 60.00-90.00 |

Run at high speed (1500 rpm) for 20 minutes;
disperse to a 5 grind; then add:

| | |
|---|---|
| EPS 2552 (styrene-acrylic resin) | 450.00-650.00 |
| RHODOLINE 654 | 06.00-10.50 |
| Glycerin | 01.00-05.00 |
| TEXANOL | 10.00-13.00 |

Mix well for 10-15 min, then add slowly:

| | |
|---|---|
| Ammonium hydroxide | 05.00-10.00 |
| BCAS | 30.00-60.00 |

Mix well then add the following slowly:

| | |
|---|---|
| ACRYSOL RM-2020 NPR (urethane thickener) | 02.00-06.00 |
| ACRYSOL RM-825 (urethane thickener) | 00.50-02.00 |
| VISCOSITY | 90-95 KU |
| pH | 8.5-9.0 |
| GRIND | 5+ |
| GLOSS | 3-4 @ |
| | (60 DEGREES) |
| ROLLOUT | NO BUBBLES |
| COLOR | STD-11F; |
| | DE = 0.25 MAX |
| STRAINING | 400M |
| | CHEESECLOTH |
| #/GAL | +/−0.2 |

PHYSICAL PROPERTIES

| DESCRIPTION | VALUE | DESCRIPTION | VALUE |
|---|---|---|---|
| TOTAL WEIGHT | 1105.139 | TOTAL VOLUME | 103.429 |
| TOTAL VEH WT % | 71.476 | TOTAL VEH VOL % | 88.293 |
| PIGMENT WT % | 28.524 | PIGMENT VOL % | 11.707 |
| VOLATILE WT % | 42.026 | VOLATILE VOL % | 55.199 |
| ORG SOLV WT % | 4.547 | ORG SOLV VOL % | 5.569 |
| SOLIDS WT % | 57.974 | SOLIDS VOL % | 44.801 |
| VEH SOLIDS WT % | 29.451 | VEH SOLIDS VOL % | 33.094 |
| DENSITY | 10.685 | SPEC GRAVITY | 1.283 |
| BULKING FACTOR | 0.094 | PVC % | 26.131 |
| P/B RATIO | 0.969 | SPREAD @ 1 MIL | 718.603 |
| CPSFA @ 1 MIL | 0.0125 | COATING VOC | 115.693 |
| MATERIAL VOC | 58.274 | TIO2 WT % | 9.049 |
| TiO2 WT % PIGMNT | 31.723 | CaCO3 WT % | 18.278 |
| CaCO3 WT % PIGMT | 64.081 | SILICATES WT % | 0.111 |
| SILCATE WT % PIG | 0.389 | OTHER PIGMT WT % | 1.086 |
| OTHR PGM WT % PG | 3.807 | RESN SOLIDS WT % | 23.060 |
| RESIN WT % VEH | 32.262 | WATER WT % | 37.513 |
| WATER WT % VEH | 52.483 | SOLVENT WT % | 4.547 |
| SOLVENT WT % VEH | 6.361 | ADDITIVES WT % | 7.443 |
| ADDITIV WT % VEH | 8.894 | OPAQUE PLMR WT % | 0.000 |
| WATER VOL % | 51.332 | | |

### Example 3

### Flame Retardant Paint that is Resistant to Mold and Insect Infestations

| DESCRIPTION | POUNDS % |
|---|---|
| Water | 120.00-160.00 |
| CELLOSIZE ER-15000M (hydroxymethylcellulose) | 00.01-02.00 |

Mix until gelled, then add:

| | |
|---|---|
| TRITON CF-10 90% (modified alkylaryl polyether) | 01.00-03.00 |
| RHODOLINE 226/35 (acrylic polymer solution) | 08.00-12.00 |
| Ethylene glycol | 08.00-12.00 |
| KTPP (triphosphoric pentapotassium salt) | 00.10-00.90 |
| RHODOLINE 654 (petroleum hydrocarbon defoamer) | 01.00-04.00 |
| PROXEL DL | 01.00-04.00 |
| KRONOS 2020 | 150.00-250.00 |
| MINEX 7 \/ MINSPAR 7 (extender; powdered silica) | 15.00-40.00 |
| BURGESS ICEBERG/H70 (extender; clay) | 30.00-70.00 |
| OMYA 4 \/ VICRON 15-(CaCO₃) | 50.00-90.00 |
| OMYA 10 \/ VICRON 45-(CaCO₃) | 12.00-30.00 |
| STAINBAN 208 (stain-blocking pigment) | 15.00-40.00 |
| MIN-U-GEL 400/ATTAGE (hydrated Al-Mg-silicate) | 01.50-05.00 |
| Boric acid | 08.00-12.00 |

Disperse to 4 grind (Hegman scale) in high speed mill; keep
temperature below 110° F.; wash mill & lines with:

| | |
|---|---|
| Water | 45.00-65.00 |
| Glycerin | 01.00-05.00 |

Let down

| | |
|---|---|
| AC-264 RHOPLEX (acrylic resin) | 270.00-350.00 |
| ROPAQUE ULTRA (opaque polymer) | 40.00-62.00 |
| RHODOLINE 654 | 06.00-10.00 |
| Ammonium hydroxide | 05.00-10.00 |

Add texanol after the paste is mixed in well

| | |
|---|---|
| TEXANOL | 15.00-20.00 |
| TROYSAN POLYPHASE P20 (mildewcide) | 04.00-08.00 |

Add the following while mixing:

| | |
|---|---|
| Diluted BCAS* | 50.00-95.00 |

Slurry the following then add while mixing:

| | |
|---|---|
| Water | 50.00-80.00 |
| CELLOSIZE ER-15000M | 02.00-08.00 |
| VISCOSITY | 90-95 KU |
| GLOSS (85′<) | 5-8 |
| GRIND | 4 |
| DRY TIME | 30 MIN |
| pH | 8.5+ |
| TINT STRENGTH | 95-105 |
| ROLLOUT | NO BUBBLING |
| STRAINING | 400M |
| | CHEESECLOTH |
| #/GAL | +/−0.2 |

PHYSICAL PROPERTIES

| DESCRIPTION | VALUE | DESCRIPTION | VALUE |
|---|---|---|---|
| TOTAL WEIGHT | 1158.966 | TOTAL VOLUME | 103.000 |
| TOTAL VEH WT % | 64.237 | TOTAL VEH VOL % | 84.175 |
| PIGMENT WT % | 35.763 | PIGMENT VOL % | 15.825 |
| VOLATILE WT % | 45.418 | VOLATILE VOL % | 61.459 |
| ORG SOLV WT % | 2.555 | ORG SOLV VOL % | 3.442 |
| SOLIDS WT % | 54.582 | SOLIDS VOL % | 38.541 |
| VEH SOLIDS WT % | 18.819 | VEH SOLIDS VOL % | 22.715 |
| DENSITY | 11.252 | SPEC GRAVITY | 1.351 |
| BULKING FACTOR | 0.089 | PVC % | 41.061 |
| P/B RATIO | 1.900 | SPREAD @ 1 MIL | 618.195 |
| CPSFA @ 1 MIL | 0.0117 | COATING VOC | 82.125 |
| MATERIAL VOC | 34.478 | TIO2 WT % | 17.257 |
| TiO2 WT % PIGMNT | 48.253 | CaCO3 WT % | 8.197 |
| CaCO3 WT % PIGMT | 22.920 | SILICATES WT % | 4.636 |
| SILCATE WT % PIG | 12.962 | OTHER PIGMT WT % | 5.674 |
| OTHR PGM WT % PG | 15.865 | RESN SOLIDS WT % | 16.542 |
| RESIN WT % VEH | 25.751 | WATER WT % | 42.840 |
| WATER WT % VEH | 66.690 | SOLVENT WT % | 2.555 |
| SOLVENT WT % VEH | 3.977 | ADDITIVES WT % | 6.615 |
| ADDITIV WT % VEH | 3.582 | OPAQUE PLMR WT % | 1.360 |
| WATER VOL % | 59.758 | | |

*Diluted BCAS is a dilution of 3 parts full strength BCAS with 1 part water.

### Example 4

### Flame Retardant Sealer that is Resistant to Mold and Insect Infestations

| DESCRIPTION | POUNDS % |
|---|---|
| RESYDROL AY 586W (alkyd resin) | 100.00-130.00 |
| ADDITOL VXW 6206 (organic drying agent) | 00.03-01.30 |
| Boric acid | 08.00-12.00 |
| Water | 30.00-60.00 |

Mix well, check pH, adjust to 8.0-8.5 by adding the following:

| | |
|---|---|
| AMP-95 | 01.00-05.00 |

Mix well, add:

| | |
|---|---|
| PROXEL DL | 01.00-05.00 |
| Glycerin | 01.00-05.00 |
| WACKER BS 17711VP POL (polysiloxane solution) | 45.00-71.00 |
| WACKER BS 1306 POLYSI (polysiloxane solution) | 06.00-10.00 |
| Ammonium hydroxide | 05.00-10.00 |

Mix well and add the following:

| | |
|---|---|
| TROYSAN POLYPHASE P20 | 01.00-05.00 |
| Water | 15.00-25.00 |

Mix well and add slowly:

| | |
|---|---|
| Water | 350.00-550.00 |
| BYK 022 (siloxane defoamer) | 00.02-02.00 |

Mix well and add the following premix slowly:

| | |
|---|---|
| Water | 05.00-09.00 |
| ACRYSOL RM-2020 NPR | 01.00-03.00 |
| Diluted BCAS* | 150.00-210.00 |
| VISCOSITY | 15-17 Sec's |
| | ZAHN # 2 cup |
| DRY TIME | 30-40 MIN |
| WATER BEADING | POSITIVE |
| pH | 8.0-8.5 |
| STRAINING | 100M |
| | CHEESECLOTH |
| #/GAL | +/−0.2 |

PHYSICAL PROPERTIES

| DESCRIPTION | VALUE | DESCRIPTION | VALUE |
|---|---|---|---|
| TOTAL WEIGHT | 866.123 | TOTAL VOLUME | 102.995 |
| TOTAL VEH WT % | 100.000 | TOTAL VEH VOL % | 100.000 |
| PIGMENT WT % | 0.000 | PIGMENT VOL % | 0.000 |
| VOLATILE WT % | 88.429 | VOLATILE VOL % | 88.801 |
| ORG SOLV WT % | 0.526 | ORG SOLV VOL % | 0.534 |
| SOLIDS WT % | 11.571 | SOLIDS VOL % | 11.199 |
| VEH SOLIDS WT % | 11.571 | VEH SOLIDS VOL % | 11.199 |
| DENSITY | 8.409 | SPEC GRAVITY | 1.010 |
| BULKING FACTOR | 0.119 | PVC % | 0.000 |
| P/B RATIO | 0.000 | SPREAD @ 1 MIL | 179.630 |
| CPSFA @ 1 MIL | 0.0539 | COATING VOC | 45.185 |
| MATERIAL VOC | 5.302 | TIO2 WT % | 0.000 |
| TiO2 WT % PIGMNT | ***** | CaCO3 WT % | 0.000 |
| CaCO3 WT % PIGMT | ***** | SILICATES WT % | 0.000 |
| SILCATE WT % PIG | ***** | OTHER PIGMT WT % | 0.000 |
| OTHR PGM WT % PG | ***** | RESN SOLIDS WT % | 9.881 |
| RESIN WT % VEH | 9.881 | WATER WT % | 87.925 |
| WATER WT % VEH | 87.925 | SOLVENT WT % | 0.526 |
| SOLVENT WT % VEH | 0.526 | ADDITIVES WT % | 1.668 |
| ADDITIV WT % VEH | 1.668 | OPAQUE PLMR WT % | 0.000 |
| WATER VOL % | 90.911 | | |

*Diluted BCAS is a dilution of 3 parts full strength BCAS with 1 part water.

### Example 5

### Stability Test

Results of a stability test on BCAS containing 10% disodium octaborate tetrahydrate (12% boric acid equivalents) for a period of one year, following 3, 6, 9, and 12 months stored in 5-gallon closed lid containers at room temperature are shown in Table 2.

Summary of Results: no Corrosion, color change or settling were observed after 3, 6, 9, or 12 months.

TABLE 2

| | INITIAL | | | 3 MONTHS | | | 6 MONTHS | | | 9 MONTHS | | | 12 MONTHS | | |
|---|---|---|---|---|---|---|---|---|---|---|---|---|---|---|---|
| | Sample No. | | | | | | | | | | | | | | |
| | 1 | 2 | 3 | 1 | 2 | 3 | 1 | 2 | 3 | 1 | 2 | 3 | 1 | 2 | 3 |
| pH | 7.83 | 7.83 | 7.83 | 7.83 | 7.83 | 7.83 | 7.83 | 7.81 | 7.82 | 7.83 | 7.81 | 7.81 | 7.83 | 7.81 | 7.81 |
| % | 100 | 100 | 100 | 100 | 100 | 100 | 100 | 100 | 100 | 100 | 100 | 100 | 100 | 100 | 100 |
| Sta- | | | | | | | | | | | | | | | |
| bility | | | | | | | | | | | | | | | |
| % | 10.00 | 10.00 | 10.00 | 10.00 | 10.00 | 10.00 | 10.00 | 10.00 | 10.00 | 10.00 | 10.00 | 10.00 | 10.00 | 10.00 | 10.00 |
| DOT | | | | | | | | | | | | | | | |
| Cor- | 0.00 | 0.00 | 0.00 | 0.00 | 0.00 | 0.00 | 0.00 | 0.00 | 0.00 | 0.00 | 0.00 | 0.00 | 0.00 | 0.00 | 0.00 |
| ro- | | | | | | | | | | | | | | | |
| sion | | | | | | | | | | | | | | | |
| Set- | 0.00 | 0.00 | 0.00 | 0.00 | 0.00 | 0.00 | 0.00 | 0.00 | 0.00 | 0.00 | 0.00 | 0.00 | 0.00 | 0.00 | 0.00 |
| tling | | | | | | | | | | | | | | | |
| Den- | 9.65 | 9.65 | 9.65 | 9.65 | 9.65 | 9.65 | 9.65 | 9.65 | 9.65 | 9.65 | 9.65 | 9.65 | 9.65 | 9.65 | 9.65 |
| sity | | | | | | | | | | | | | | | |
| Sp. | 1.16 | 1.16 | 1.16 | 1.16 | 1.16 | 1.16 | 1.16 | 1.16 | 1.16 | 1.16 | 1.16 | 1.16 | 1.16 | 1.16 | 1.16 |
| Grav- | | | | | | | | | | | | | | | |
| ity | | | | | | | | | | | | | | | |

### Example 6

### Resistance to Growth of Mold on the Surface of Interior Coatings in an Environmental Center

Paint with and without BCAS were applied on materials to demonstrate the effect of coverage on varying surfaces and material susceptibilities. Glass fiber (as filer paper) was added to evaluate susceptibility of the paint itself on a non-nutritive base. Test sample were incubated in an exposure chamber specified by the method (ASTM D3273). Samples were hung over conditioned soil that was inoculated with the following fungi: Aureobasidium pullulans, ATCC 9348, Aspergillus niger, ATCC 6275, and Penicillum citrium, ATCC 9849. Proper exposure conditions were verified by the inclusion of microbial viability plates and positive controls: wood, gypsum board or other mold susceptible materials. Mold development or defacements of the materials was rated weekly on a visual scale. The exposure period was initially planned for 4 weeks.

TABLE 3
Resistance to Mold Growth ASTM D3273: Paint on Selected Surfaces

| | | ASTM D 3273 Weekly Ratings* | | | | | | | | | |
|---|---|---|---|---|---|---|---|---|---|---|---|
| | | Week 1 | | Week 2 | | Week 3 | | Week 4 | | Week 6 | |
| | Replicate | + | − | + | − | + | − | + | − | + | − |
| Pine | A | 10 | 10 | 10 | 10 | 10 | 10 | 10 | 9 | 10 | 7 |
| | B | 10 | 10 | 10 | 10 | 10 | 9 | 10 | 9 | 10 | 7 |
| | C | 10 | 10 | 10 | 10 | 10 | 9 | 10 | 9 | 10 | 7 |
| Wall Board | A | 10 | 10 | 10 | 10 | 10 | 10 | 10 | 9 | 10 | 8 |
| | B | 10 | 10 | 10 | 10 | 10 | 9 | 10 | 9 | 10 | 9 |
| | C | 10 | 10 | 10 | 10 | 10 | 9 | 10 | 9 | 10 | 8 |
| Paper | A | 10 | 10 | 10 | 10 | 10 | 10 | 10 | 10 | 10 | 10 |
| | B | 10 | 10 | 10 | 10 | 10 | 10 | 10 | 10 | 10 | 10 |
| | C | 10 | 10 | 10 | 10 | 10 | 10 | 10 | 10 | 10 | 10 |
| Glass Fiber | A | 10 | 10 | 10 | 10 | 10 | 10 | 10 | 10 | 10 | 10 |
| | B | 10 | 10 | 10 | 10 | 10 | 10 | 10 | 9 | 10 | 10 |
| | C | 10 | 10 | 10 | 10 | 10 | 10 | 10 | 10 | 10 | 10 |

Test Controls (shared)

| | Week 1 | Week 2 | Week 3 | Week 4 | Week 6 |
|---|---|---|---|---|---|
| Pine | 7 | 5 | 3 | 2 | 1 |
| Cork | 8 | 7 | 7 | 7 | 6 |
| Leather | 8 | 7 | 7 | 7 | 6 |
| Birch | 8 | 5 | 3 | 1 | 1 |

*Rating: Complete growth or defacement = 1. No growth = 10.
+ indicates paint containing BCAS.
− indicates paint without BCAS.

Because at 3-4 weeks mold had just penetrated the paint film barrier of the paint without the BCAS, the analysis was continued for a further two weeks in order to differentiate the effects of BCAS in the treatment group. Paint samples containing BCAS were found to be resistant to mold growth when tested as described. The paint without BCAS was not found resistant.

### Example 7

### Standard Flame Spread and Smoke Density Tests

TEST 1: Primer and sealer containing BCAS were tested by standard flame spread and smoke density development classification tests in accordance with ASTM Designation E84-03, “Standard Method for Test for Surface Burning Characteristics of Building Materials.” This test is comparable to UL 723, ANSI/NFPA No. 255, and UBC No. 8-1.

Three pieces of CDX plywood sized 24″ by 96″ were treated with the primer and sealer. The primer was roller applied at normal coverage rate of 100 sqft/gal in one coat and allowed to dry for a minimum of two hours. The sealer was roller applied at normal coverage rate of 200 sqft/gal in one coat and allowed to dry for a minimum of five days prior to testing. The specimens were placed in the conditioning room, which is maintained at 73.4±5° F. and a relative humidity of 50±5%, and allowed to reach moisture equilibrium. Results of Tests 1 and 2 are summarized in Tables 4 and 5, respectively.

TABLE 4
FLAME SPREAD RESULTS-TEST 1

| IGNITION | 2 minutes, 4 seconds |
|---|---|
| FLAME FRONT | 5 feet maximum |
| Time to Maximum Spread | 4 minutes, 32 seconds |
| Test Duration | 10 minutes |
| Calculation | 33.14 × 0.515 = 17.07 |
| FLAME SPREAD | 15* |
| SMOKE DENSITY | 60* |

*Results are adjusted to the nearest figure divisible by 5 because of the possible variations in reproducibility.

Sample surface ignition was observed at 2 minutes, 4 seconds. A flame front advance of 5 feet was observed at 4 minutes, 32 seconds. As indicated below in Table 6, the BCAS-containing primer and sealer qualified as a National Fire Protection Association Class A flame retardant and as a Uniform Building Code Class I flame retardant.

TABLE 5
FLAME SPREAD RESULTS-TEST 2

| IGNITION | 59 seconds |
|---|---|
| FLAME FRONT | 5.5 feet maximum |
| Time to Maximum Spread | 8 minutes, 50 seconds |
| Test Duration | 10 minutes |
| Calculation | 31.55 × 0.515 = 16.25 |
| FLAME SPREAD | 15* |
| SMOKE DENSITY | 35* |

*Results are adjusted to the nearest figure divisible by 5 because of the possible variations in reproducibility.

Sample surface ignition was observed at 59 seconds. A flame front advance of 5.5 feet was observed at 8 minutes, 50 seconds. As indicated below in Table 6, the BCAS-paint qualifies as a National Fire Protection Association Class A flame retardant and as a Uniform Building Code Class I flame retardant.

TABLE 6

| National Fire | Uniform Building | |
|---|---|---|
| Protection Association Class | Code Class | Flame Spread |
| A | I | 0 through 25 |
| B | II | 26 through 75 |
| C | III | 76 through 200 |

1. National Fire Protection Association, ANSI/NFPA No. 101, “Life Safety Code”, 1994 Edition.
2. Uniform Building Code, 1994 Edition, Chapter 8, Interior Finishes, Sections 801-807.

### Example 8

### Evaluation of Termite Resistance of Oriented Strand Board (“OSB”) Wafers Treated with the Boron-Containing Aqueous Solution

In this study, the resistance of oriented standard board (“OSB”) samples containing various combinations of BCAS to attack by the Formosan subterranean termite in laboratory tests following the American Wood Preservers Association AWPA E1-97 protocol for laboratory evaluation of termite resistance. In this test, each test wafer of OSB is exposed to 400 Formosan subterranean termites for four weeks (28 days). The test represents severe termite exposure since the termites are freshly collected from field locations immediately before the test and then kept under warm and human conditions ideal for survival and feeding. Typically, Douglas fir wafers are virtually destroyed in a four-week test period. At the conclusion of the test period, the wafers are visually rated according to the AWP rating scale, where a rating of 10 indicates no attack and zero is complete failure of the test wafers. The oven dry weight change of the test wafers and termite mortality were also evaluated.

Materials and Methods:

OSB test wafers were prepared by Borden Chemical according to the AWPA protocol, the dimensions of each wafer are 25×25×10-cm. The treatments are as follows:
RED: untreated
GREEN: BCAS (undiluted, full-strength)
PURPLE: BCAS (undiluted, full-strength) coated with diluted BCAS* (applied to the edges which was brushed on).
ORANGE: BCAS (undiluted, full-strength) and diluted BCAS* (applied to the edges and face of the wafer brushed on).
   * 3 parts BCAS were diluted with 1 part water.

The wafers were oven-dried at 34° C. for 72 hours to obtain dry weights prior to termite exposure. A single dry OSB wafer was placed on the surface of 150 g of damp silica sand moistened with 30 ml of distilled water inside a screw-top jar (dimensions: 8 cm diameter, 10 cm high). Formosan subterranean termites, Coptotermes formosanus Shiraki, were collected from an active field colony at the Pearl City Urban Garden Center (Oahu, Hi.) immediately before the laboratory test using a chopping technique (Tamashiro, et al. 1973). 400 termites (360 workers and 40 soldiers to approximate natural cast proportions in field colonies) were added to each test jar. Each treatment was replicated five times. In addition, three “environmental control” control wafers of each material were exposed to the same test conditions of the other wafers, except that no termites were added to the jars. The environmental control wafers are used to recognize any weight change in the wafers due to absorbing moisture or any other factors unrelated to termite attack. After adding termites, the jars were placed in an unlighted, controlled temperature cabinet at 28° C. for four weeks (28 days) as specified in AWPA E1-97. Each jar was inspected weekly for evidence of termite activity in the soil and on the test materials. At the conclusion of the four-week test period, percentage termite mortality was recorded. The wafers were rated visually according to the AWPA 0-10 scale (where 10 is sound, 9 is light attack, 7 is moderate attack and penetration, 4 is heavy attack, and 0 is total failure of the wood sample. The oven dry weight change of each wafer was also reported.

Results

Results are summarized in Tables 7-11 below. Table 7 summarizes the changes in visual ratings and dry wood weight throughout the test. Tables 8-11 summarize the observations from weeks 1-4, respectively. As is apparent from the four tables (Tables 8-11) of observations recorded each week during the four-week test period, termites were extremely active on the untreated OSB wafers (RED) throughout the test. The untreated wafers suffered heavy attack (mean visual rating of 4) and an average 24% weight loss attributable to termite feeding. The OSB wafers containing BCAS (undiluted, full-strength) alone (GREEN) were also heavily attacked (mean visual rating of 4). The exposure to the BCAS (undiluted, full-strength) was clearly toxic to the insects after the first two weeks resulting in 57% average termite mortality and wafer weight losses slightly less (15% average weight loss) than those observed with the untreated with the OSB.

Brush treatment of the edges and face of the OSB containing BCAS (undiluted, full-strength) with the diluted BCAS (ORANGE) greatly suppressed termite exploration of the wood, with only two of the wafers showing any sign of attack after four weeks (rated 9 and 7, with an average rating of 9.2 for the five wafers). With this treatment, the resulting wood weight loss from the small amount of feeding was reduced to less than 2%. An equivalent reduction in termite activity was obtained when the face of the OSB containing BCAS (undiluted, full-strength) was coated with a clear coating and the edges were brush-treated with the diluted BCAS (PURPLE). Under these conditions, only one of the five wafers was attacked (rating of 7, with an overall average rating of 9.4; mean weight loss of less than 2%). A slight increase in mortality with the diluted BCAS brush treatments, coupled with reduced termite exploration of the treated wafers indicates that the BCAS (undiluted, full-strength) is a rather slow acting poison to the insects, but not repellant to them, and that the diluted BCAS is largely repellant in action, but attributes a slight additional toxicity to the treated OSB.

In the case of the coated wafers with the edges brushed with the diluted BCAS (PURPLE), there was no termite penetration of the face coating. In the single wafer in this treatment with termite penetration through one edge, it appeared that the termites had initially tunneled into the juncture between two laminations. Since some swelling and delamination was noted in all the OSB treatments, probably due to the damp test conditions and subsequent over-drying, it is possible that tunneling termites avoided contact with the brush treated wafer edge by entering this crack between two laminations. This same phenomena has been observed with pressure-treated solid wood where termites were unable to penetrate the surface directly, but are able to enter through checks in the board (personal observation). In the case of the two wafers where the edges and faces have been brush-treated with the diluted BCAS, the single termite penetration in each wafer appeared to be directly through a rather large wood particle on the face of the wafer, possibly due to limited penetration of the topically applied diluted boron-containing aqueous solution into these single large particles. OSB is not a homogeneous product and the treatment properties of adjacent wood fragments in the product could differ, for example, hard wood versus soft wood fragments.

Even with the three wafers mentioned above, however, which each evidenced a single termite penetration point, it is important to note that (1) termite attack on each of the three wafers was, in fact, limited to a single penetration point, (2) the penetrations terminated directly below the wafer surface and did not lead into any network of internal tunnels, and (3) all termites exposed to each of these three wafers died (100% mortality) due to the combined toxicity of the diluted BCAS and the undiluted, full-strength BCAS. Moreover, the degree of termite attack overall on these treatments was equivalent to or less than that observed on solid wood wafers treated with disodium octaborate tetrahydrate (Tim-Bor) in similar laboratory tests (Grace 1998, Grace & Yamamoto 1994).

Thus, these laboratory results demonstrate that OSB containing BCAS (undiluted, full-strength) and brushed treated with diluted BCAS is quite termite resistant, whether or not the face is coated. Further enhancement of this termite resistance could be achievable by reducing the size or improving the homogeneity of the wood fragments in the composite board and by reducing any swelling and subsequent delamination of the boards. However, even without such improvements, the combination of repellants and toxicity of this combination appear to greatly limit any termite penetration, but may occasionally occur (1 of 5 wafers in one treatment, and 2 of 5 treatments in the other) and result in the death of the invaders.

### REFERENCES

1. American Wood Preservers Association (1998), Standard Method for Laboratory Evaluation to Determine Resistance to Subterranean Termites, E1-97, AWPA Book of Standards.
Grace, J. K. (1998), Resistance of Pine Treated With Chromated Copper Arsenate to the Formosan Subterranean Termite, Florists Products Journal 48(3):79-82.
3. Grace, J. K. and R. T. Yamamoto (1994), Natural Resistance of Alaska-Cedar Redwood, Teak to Formosan Subterranean Termites, Florists Products Journal 44(3): 41-45.
4. Tamashiro, M., Fujii J. K, and Lai, P. Y. (1973), A Simple Method to Observe, Trap and Prepare Large Numbers of Subterranean Termites for Laboratory and Field Experiments, Environmental Entomology 2:721-722.

Those skilled in the art will recognize or be able to ascertain, using no more than routine experimentation, many equivalents of the specific embodiments of the invention described therein. Such equivalents are intended to be encompassed by the following claims.

TABLE 7

| | | AWPA | Mean | Dry | Dry | Wt. | % | | | Mean % | |
|---|---|---|---|---|---|---|---|---|---|---|---|
| | | Visual | AWPA | Wt. | Wt. | Loss | Wt. | Mean Wt | | WL | |
| Treatment | Replicate | Rating* | Rating* | before | after | (g) | Loss | Loss (mg) | SD | Loss | SD |
| red | 1 | 4 | 4 | 4.5453 | 3.3671 | 1.1782 | 25.92 | 1143.38 | 57.10 | 25.12 | 0.95 |
| | 2 | 4 | | 4.2331 | 3.1486 | 1.0845 | 25.62 | ADJUSTED | ADJUSTED | | |
| | 3 | 4 | | 4.8942 | 3.6707 | 1.2235 | 25.00 | WT LOSS: | % WT LOSS: | | |
| | 4 | 4 | | 4.6838 | 3.5821 | 1.1017 | 23.52 | 1068.91 | | 23.52 | |
| | 5 | 4 | | 4.4185 | 3.2895 | 1.1290 | 25.55 | | | | |
| green | 1 | 4 | 4 | 4.7607 | 4.0277 | 0.7330 | 15.40 | 597.64 | 105.03 | 15.33 | 0.79 |
| | 2 | 4 | | 4.1095 | 3.4949 | 0.6146 | 14.95 | ADJUSTED | ADJUSTED | | |
| | 3 | 4 | | 5.1573 | 4.2982 | 0.8591 | 16.66 | WT LOSS: | % WT LOSS: | | |
| | 4 | 4 | | 4.1059 | 3.5066 | 0.5993 | 14.60 | 697.47 | | 15.33 | |
| | 5 | 4 | | 4.5334 | 3.8512 | 0.6822 | 15.05 | | | | |
| purple | 1 | 10 | 9.4 | 5.1516 | 5.0899 | 0.0617 | 1.20 | 101.72 | 55.50 | 2.24 | 1.41 |
| | 2 | 10 | | 5.1808 | 5.0890 | 0.0918 | 1.77 | ADJUSTED | ADJUSTED | | |
| | 3 | 10 | | 3.8156 | 3.6850 | 0.1306 | 3.42 | WT LOSS: | % WT LOSS: | | |
| | 4 | 10 | | 5.3842 | 5.3411 | 0.0431 | 0.80 | 75. | | 1.72 | |
| | 5 | 7 | | 4.5069 | 4.3255 | 0.1814 | 4.02 | | | | |
| orange | 1 | 7 | 9.2 | 5.2886 | 5.1404 | 0.1482 | 2.80 | 94.94 | 30.66 | 1.84 | 0.61 |
| | 2 | 9 | | 5.6762 | 5.5894 | 0.0868 | 1.53 | ADJUSTED | ADJUSTED | | |
| | 3 | 10 | | 4.5700 | 4.4860 | 0.0840 | 1.84 | WT LOSS: | % WT LOSS: | | |
| | 4 | 10 | | 6.0413 | 5.9722 | 0.0691 | 1.14 | 73.51 | | 1.54 | |
| | 5 | 10 | | 4.6392 | 4.5526 | 0.0866 | 1.87 | | | | |
| AMBIENT CONTROLS | | | | | | | | | | | |
| (no termites) | | | | | | | | | | | |
| red | 1 | | | 4.2647 | 4.1748 | 0.0899 | 2.11 | 74.47 | 13.39 | 1.61 | 0.44 |
| | 2 | | | 4.6564 | 4.5887 | 0.0676 | 1.45 | | | | |
| | 3 | | | 5.2301 | 5.1642 | 0.0658 | 1.28 | | | | |
| green | 1 | | | 4.6118 | 4.6011 | 0.0107 | 0.23 | 0.17 | 9.24 | 0.00 | 0.20 |
| | 2 | | | 4.7769 | 4.7805 | −0.004 | −0.08 | | | | |
| | 3 | | | 4.6274 | 4.6340 | −0.007 | −0.14 | | | | |
| purple | 1 | | | 5.2914 | 5.2636 | 0.0278 | 0.53 | 25.83 | 6.29 | 0.53 | 0.12 |
| | 2 | | | 4.5754 | 4.5566 | 0.0188 | 0.41 | | | | |
| | 3 | | | 4.7667 | 4.7358 | 0.0309 | 0.65 | | | | |
| orange | 1 | | | 5.8046 | 5.7841 | 0.0205 | 0.35 | 16.43 | 11.74 | 0.30 | 0.22 |
| | 2 | | | 5.3355 | 5.3099 | 0.0256 | 0.48 | | | | |
| | 3 | | | 6.0052 | 6.002 | 0.0032 | 0.05 | | | | |

| | | Mean % | | W | S | W | S | Total % |
|---|---|---|---|---|---|---|---|---|
| Treatment | Replicate | Mortality | SD | alive | alive | dead | dead | Mortality |
| red | 1 | 11.95 | 3.03 | 303 | 35 | 57 | 5 | 15.50 |
| | 2 | | | 314 | 36 | 46 | 4 | 12.50 |
| | 3 | | | 333 | 36 | 27 | 4 | 7.75 |
| | 4 | | | 321 | 38 | 39 | 2 | 10.25 |
| | 5 | | | 309 | 36 | 51 | 4 | 13.75 |
| green | 1 | 57.05 | 11.45 | 201 | 40 | 159 | 0 | 39.75 |
| | 2 | | | 113 | 22 | 247 | 18 | 66.25 |
| | 3 | | | 149 | 0 | 211 | 40 | 62.75 |
| | 4 | | | 119 | 19 | 241 | 21 | 65.50 |
| | 5 | | | 161 | 35 | 199 | 5 | 51.00 |
| purple | 1 | 61.40 | 26.18 | 144 | 0 | 216 | 40 | 64.00 |
| | 2 | | | 126 | 0 | 234 | 40 | 68.50 |
| | 3 | | | 236 | 0 | 124 | 40 | 41.00 |
| | 4 | | | 266 | 0 | 94 | 40 | 33.50 |
| | 5 | | | 0 | 0 | 360 | 40 | 100.00 |
| orange | 1 | 77.70 | 25.91 | 0 | 0 | 360 | 40 | 100.00 |
| | 2 | | | 0 | 0 | 360 | 40 | 100.00 |
| | 3 | | | 200 | 0 | 160 | 40 | 50.00 |
| | 4 | | | 202 | 0 | 158 | 40 | 49.50 |
| | 5 | | | 44 | 0 | 316 | 40 | 89.00 |

| AMBIENT | |
|---|---|
| CONTROLS | |
| (no termites) | |
| red | 1 |
| | 2 |
| | 3 |
| green | 1 |
| | 2 |
| | 3 |
| purple | 1 |
| | 2 |
| | 3 |
| orange | 1 |
| | 2 |
| | 3 |

TABLE 8

| | | | | | % Wood | | |
|---|---|---|---|---|---|---|---|
| | | Activity on | Tunneling- | Tunneling- | covered | | |
| Set # | Rep # | wood | wood | sand | w/sand | Fungus | Comments |
| red | 1 | high | moderate | extensive | 5 | no | Very active |
| | 2 | high | high | extensive | 10 | no | Very active |
| | 3 | high | moderate | extensive | 5 | no | Very active |
| | 4 | high | moderate | extensive | 0 | no | Very active |
| | 5 | high | high | extensive | 5 | no | Very active |
| | Control 1 | — | — | — | — | no | |
| | Control 2 | — | — | — | — | no | |
| | Control 3 | — | — | — | — | no | |
| green | 1 | high | moderate | extensive | 0 | no | Very active |
| | 2 | high | high | extensive | 5 | no | Very active |
| | 3 | — | — | extensive | 5 | no | Very active |
| | 4 | — | — | extensive | 0 | no | Very active |
| | 5 | — | — | extensive | 0 | no | Very active |
| | Control 1 | — | — | — | — | no | |
| | Control 2 | — | — | — | — | no | |
| | Control 3 | — | — | — | — | no | |
| purple | 1 | — | — | extensive | 0 | no | Very active |
| | 2 | — | — | extensive | 0 | no | |
| | 3 | — | — | extensive | 0 | no | |
| | 4 | — | — | extensive | 0 | no | |
| | 5 | — | — | extensive | 10 | no | Very active |
| | Control 1 | — | — | — | — | no | |
| | Control 2 | — | — | — | — | no | |
| | Control 3 | — | — | — | — | no | |
| orange | 1 | — | — | extensive | 0 | no | Very active |
| | 2 | — | — | extensive | 0 | no | Slow |
| | 3 | — | — | extensive | 0 | no | Very active |
| | 4 | — | — | extensive | 0 | no | Very active |
| | 5 | — | — | extensive | 0 | no | Very active |
| | Control 1 | — | — | — | — | no | |
| | Control 2 | — | — | — | — | no | |
| | Control 3 | — | — | — | — | no | |

TABLE 9

| | | | | | % Wood | | |
|---|---|---|---|---|---|---|---|
| | | Activity on | Tunneling- | Tunneling- | covered | | |
| Set # | Rep # | wood | wood | sand | w/sand | Fungus | Comments |
| red | 1 | high | high | extensive | 5 | no | Very active |
| | 2 | high | high | extensive | 10 | no | Very active |
| | 3 | high | high | extensive | 5 | no | Very active |
| | 4 | high | high | extensive | 0 | no | Very active |
| | 5 | high | high | extensive | 5 | no | Very active |
| | Control 1 | — | — | — | — | yes | Gray/white |
| | | | | | | | fungus on wafer |
| | Control 2 | — | — | — | — | yes | Black/gray |
| | | | | | | | fungus on wafer |
| | Control 3 | — | — | — | — | yes | Black/gray |
| | | | | | | | fungus on wafer |
| green | 1 | high | moderate | extensive | 5 | no | Very active |
| | 2 | high | high | extensive | 5 | no | Very active |
| | 3 | — | moderate | extensive | 5 | no | Very active |
| | 4 | high | moderate | extensive | 5 | no | Very active |
| | 5 | low | low | extensive | 0 | no | Very active |
| | Control 1 | — | — | — | — | no | |
| | Control 2 | — | — | — | — | no | |
| | Control 3 | — | — | — | — | no | |
| purple | 1 | — | — | extensive | 0 | no | Very active |
| | 2 | — | — | extensive | 0 | no | |
| | 3 | — | — | extensive | 0 | no | |
| | 4 | — | — | extensive | 0 | no | |
| | 5 | — | — | extensive | 10 | no | Very active |
| | Control 1 | — | — | — | — | no | |
| | Control 2 | — | — | — | — | no | |
| | Control 3 | — | — | — | — | no | |
| orange | 1 | — | — | extensive | 0 | no | Very active |
| | 2 | — | — | extensive | 0 | no | |
| | 3 | — | — | extensive | 0 | no | Very active |
| | 4 | — | — | extensive | 0 | no | Very active |
| | 5 | — | — | extensive | 0 | no | Very active |
| | Control 1 | — | — | — | — | no | |
| | Control 2 | — | — | — | — | no | |
| | Control 3 | — | — | — | — | no | |

TABLE 10

| | | | | | % Wood | | |
|---|---|---|---|---|---|---|---|
| | | Activity on | Tunneling- | Tunneling- | covered | | |
| Set # | Rep # | wood | wood | sand | w/sand | Fungus | Comments |
| red | 1 | high | high | extensive | 5 | no | Very active |
| | 2 | high | high | extensive | 10 | no | Very active |
| | 3 | high | high | extensive | 5 | no | Very active; |
| | | | | | | | Building on wafer |
| | 4 | high | high | extensive | 0 | no | Very active; |
| | | | | | | | Building on wafer |
| | 5 | high | high | extensive | 5 | no | Very active; |
| | | | | | | | Building on wafer |
| | Control 1 | — | — | — | — | yes | Gray fungus on |
| | | | | | | | wafer |
| | Control 2 | — | — | — | — | yes | Black/gray fungus |
| | | | | | | | on wafer |
| | Control 3 | — | — | — | — | yes | Black/gray fungus |
| | | | | | | | on wafer |
| green | 1 | high | moderate | extensive | 5 | no | Several dead in |
| | | | | | | | tunnels |
| | 2 | — | high | extensive | 5 | no | Several dead in |
| | | | | | | | tunnels |
| | 3 | low | moderate | extensive | 5 | no | Several dead in |
| | | | | | | | tunnels |
| | 4 | high | moderate | extensive | 5 | no | Several dead in |
| | | | | | | | tunnels |
| | 5 | high | moderate | extensive | 0 | no | Several dead in |
| | | | | | | | tunnels |
| | Control 1 | — | — | — | — | yes | White fungus on |
| | | | | | | | wafer |
| | Control 2 | — | — | — | — | yes | White fungus on |
| | | | | | | | wafer |
| | Control 3 | — | — | — | — | yes | White fungus on |
| | | | | | | | wafer |
| purple | 1 | — | — | extensive | 0 | no | Abs starting to |
| | | | | | | | flatten |
| | 2 | — | — | extensive | 0 | no | Abs starting to |
| | | | | | | | flatten |
| | 3 | — | — | extensive | 0 | no | Abs starting to |
| | | | | | | | flatten |
| | 4 | — | — | extensive | 0 | no | Abs starting to |
| | | | | | | | flatten |
| | 5 | — | — | extensive | 10 | no | Abs starting to |
| | | | | | | | flatten |
| | Control 1 | — | — | — | — | no | |
| | Control 2 | — | — | — | — | no | |
| | Control 3 | — | — | — | — | no | |
| orange | 1 | high | moderate | extensive | 0 | no | Several dead in |
| | | | | | | | tunnels |
| | 2 | — | low | extensive | 0 | no | Several dead in |
| | | | | | | | tunnels |
| | 3 | — | — | extensive | 0 | no | Several dead in |
| | | | | | | | tunnels |
| | 4 | — | — | extensive | 0 | no | Abs starting to |
| | | | | | | | flatten |
| | 5 | — | — | extensive | 0 | no | Abs starting to |
| | | | | | | | flatten |
| | Control 1 | — | — | — | — | no | |
| | Control 2 | — | — | — | — | no | |
| | Control 3 | — | — | — | — | no | |

TABLE 11

| | | | | | % Wood | | |
|---|---|---|---|---|---|---|---|
| | | Activity on | Tunneling- | Tunneling- | covered | | |
| Set # | Rep # | wood | wood | sand | w/sand | Fungus | Comments |
| red | 1 | high | high | extensive | 5 | no | Very active |
| | 2 | high | high | extensive | 10 | no | Very active |
| | 3 | high | high | extensive | 5 | no | Very active; |
| | | | | | | | Building on wafer |
| | 4 | high | high | extensive | 0 | no | Very active; |
| | | | | | | | Building on wafer |
| | 5 | high | high | extensive | 5 | no | Very active; |
| | | | | | | | Building on wafer |
| | Control 1 | — | — | — | — | yes | Gray fungus on |
| | | | | | | | wafer |
| | Control 2 | — | — | — | — | yes | Black/gray fungus |
| | | | | | | | on wafer |
| | Control 3 | — | — | — | — | yes | Black/gray fungus |
| | | | | | | | on wafer |
| green | 1 | high | high | extensive | 5 | no | Several dead in |
| | | | | | | | tunnels |
| | 2 | high | high | extensive | 5 | no | Several dead in |
| | | | | | | | tunnels; Slow |
| | 3 | — | moderate | extensive | 5 | no | Several dead in |
| | | | | | | | tunnels; Slow; |
| | | | | | | | Black fungus on |
| | | | | | | | wafer |
| | 4 | high | moderate | extensive | 5 | no | Several dead in |
| | | | | | | | tunnels |
| | 5 | high | high | extensive | 0 | yes | Several dead in |
| | | | | | | | tunnels; Slow; |
| | | | | | | | Black fungus on |
| | | | | | | | wafer |
| | Control 1 | — | — | — | — | yes | White fungus on |
| | | | | | | | wafer |
| | Control 2 | — | — | — | — | yes | White fungus on |
| | | | | | | | wafer |
| | Control 3 | — | — | — | — | yes | White fungus on |
| | | | | | | | wafer |
| purple | 1 | — | — | extensive | 0 | no | Abs flattening; |
| | | | | | | | Few dead in |
| | | | | | | | tunnels; Not many |
| | | | | | | | visible; Slow |
| | 2 | — | — | extensive | 0 | no | Abs flattening; |
| | | | | | | | Few dead in |
| | | | | | | | tunnels; Not many |
| | | | | | | | visible; Slow |
| | 3 | — | — | extensive | 0 | no | Abs flattening; |
| | | | | | | | Few dead in |
| | | | | | | | tunnels; Not many |
| | | | | | | | visible; Slow |
| | 4 | — | — | extensive | 0 | no | Abs flattening; |
| | | | | | | | Few dead in |
| | | | | | | | tunnels; Slow |
| | 5 | — | — | extensive | 10 | no | No live termites |
| | | | | | | | visible |
| | Control 1 | — | — | — | — | no | |
| | Control 2 | — | — | — | — | no | |
| | Control 3 | — | — | — | — | no | |
| orange | 1 | — | moderate | extensive | 0 | no | No live termites |
| | | | | | | | visible |
| | 2 | — | low | extensive | 0 | no | No live termites |
| | | | | | | | visible |
| | 3 | — | — | extensive | 0 | no | Abs flattening; |
| | | | | | | | Few dead in |
| | | | | | | | tunnels; Not many |
| | | | | | | | visible; Slow |
| | 4 | — | — | extensive | 0 | no | Abs flattening; |
| | | | | | | | Few dead in |
| | | | | | | | tunnels; Not many |
| | | | | | | | visible; Slow |
| | 5 | — | — | extensive | 0 | no | No live termites |
| | | | | | | | visible |
| | Control 1 | — | — | — | — | no | |
| | Control 2 | — | — | — | — | no | |
| | Control 3 | — | — | — | — | no | |

1. A composition for rendering a material flame retardant and resistant to molds and insects, comprising a metallic borate, a methyl donor, an acid, an alcohol, and an ammonium base.

2. The composition of claim 1, wherein said metallic borate is selected from the group consisting of disodium tetraborate decahydrate, disodium octaborate tetrahydrate, sodium metaborate, sodium perborate monohydrate, disodium octaborate, sodium tetraborate pentahydrate, sodium tetraborate, copper metaborate, potassium borate and zinc borate.

3. The composition of claim 1, wherein a concentration of the metallic borate is up to about 90% by weight.

4. The composition of claim 1, wherein a concentration of the metallic borate is between about 5 to 15% by weight.

5. The composition of claim 1, wherein the methyl donor is selected from the group consisting of tetramethylglycine and trimethylglycine.

6. The composition of claim 5, wherein a concentration of the methyl donor is up to about 30% by weight.

7. The composition of claim 5, wherein a concentration of the methyl donor is about 5% by weight.

8. The composition of claim 1, wherein the acid is a mineral acid.

9. The composition of claim 8, wherein the mineral acid is selected from the group consisting of hydrochloric acid, phosphoric acid and hydrobromic acid.

10. The composition of claim 8, wherein a concentration of the mineral acid is up to about 30% by weight.

11. The composition of claim 8, wherein a concentration of the mineral acid is between about 1-5% by weight

12. The composition of claim 1, wherein the alcohol is an ester alcohol.

13. The composition of claim 12, wherein the ester alcohol is TEXANOL.

14. The composition of claim 12, wherein a concentration of the ester alcohol is up to about 40% by weight.

15. The composition of claim 12, wherein a concentration of the ester alcohol is between about 1-15% by weight.

16. The composition of claim 1, further comprising urea.

17. The composition of claim 16, wherein a concentration of the urea is between about 0 and 25% by weight.

18. The composition of claim 16, wherein a concentration of the urea is between about 0 and 10% by weight.

19. The composition of claim 1, further comprising an insecticidal and/or antifungal agent.

20. The composition of claim 19, wherein the insecticidal and/or antifungal agent is selected from the group consisting of DOWCIL-75, parabens, methyl paraben, propyl paraben, disodium cyanodithioimidocarbonate, methylene bis thiocyanate; isothiazolin, glutaraldehyde, dithiocarbamates, quaternary ammonium compounds, dibromonitrilopropionamide, dibromo dicyano butane, dodecylguanidine hydrochloride, organophosphate compounds, malathion, ethl-parathion, diazinon, organosulfur insecticides, tetradifon, propargite, ovex, carbamate compounds, carbaryl, methomyl, carbofuran, aldicarb, oxamyl, thiodicarb, methiocarb, propoxur, bendiocarb, carbosulfam, aldoxycarb, 3-iodo-2-propynyl butyl carbamate, promecarb, fenoxycarb, formamidine insecticides, amitraz, dinitropheol compounds, 2,4-dinitrophenol, organotin insecticides, cyhexatin, pyrethroid compounds, allethrin, tetramethrin, fenvalerate, acrinathrin, permethrin, nicotinoid compounds, 1-(6-chloro-3-pyridin-3-ylmethyl)-n-nitro-imidazolidin-2-ylidenamine, phenol compounds, 2-phenylphenol and mixtures thereof.

21. The composition of claim 19, wherein a concentration of the insecticidal and/or antifungal agent is between about 0 and 30% by weight.

22. The composition of claim 19, wherein a concentration of the insecticidal and/or antifungal agent is between about 0 and 10% by weight.

23. The composition of claim 1, further comprising a coupling agent selected from the group consisting of glycol ethers, linear or branched C₁-C₁₂ alcohols, linear or branched C₁-C₁₂ acetates, alkali salts of alkyl, aryl, or alkylaryl sulfonates, modified alkylaryl polyether surfactants, nonionic surfactants, betaine surfactants, fatty acids, and ketones and mixtures thereof.

24. The composition of claim 1, further comprising a foaming agent.

25. The composition of claim 1, further comprising a rheology modifier.

26. The composition of claim 1, further comprising a surfactant.

27. A wash for treating wood or wood products, comprising the composition of claim 1.

28. A waterproofing formulation for treating wood or wood products, comprising a conventional sealer, and further comprising the composition of claim 1.

29. A primer for covering wood or wood products, comprising a conventional primer formulation, and further comprising the composition of claim 1.

30. A paint for covering wood or wood products, comprising a conventional paint formulation, and further comprising the composition of claim 1.

31. A method for treating or preventing fungal growth on a material, comprising applying to said material a formulation comprising an amount of the composition of claim 1, said amount being effective for treating or preventing the fungal growth.

32. A method for treating or preventing insect infestation on a material, comprising applying to said material a formulation comprising an amount of the composition of claim 1, said amount being effective for treating or preventing the insect infestation.

33. The method of claim 32, further comprising drilling holes in said material and applying said formulation into said holes.

34. The method of claim 32, wherein said formulation is in provided as a foam.

35. A method for rendering a material flame retardant, comprising applying to said material a formulation comprising an amount of the composition of claim 1, said amount being effective for rendering said material flame retardant.

36. A method for rendering a material resistant to fungal growth, insect infestation and flame spread, comprising applying to said material a formulation comprising an amount of the composition of claim 1, said amount being effective for rendering said material resistant to fungal growth, insect infestation and flame spread.

37. A material, which has been rendered resistant to fungal growth, insect infestation and flame spread, by applying to said material a formulation comprising an amount of the composition of claim 1, said amount being effective for rendering said material resistant to fungal growth, insect infestation and flame spread.

38. The material of claim 37, wherein the step of applying further comprises pressure-treating said material.

39. The material of claim 37, wherein the step of applying further comprises slurrying a wood-derived precursor material in the presence of a glue.

40. The material of claim 37, wherein said material is green lumber.

41. The material of claim 37, wherein said material is engineered wood.

42. The material of claim 37, wherein said material is treated wood.

43. The material of claim 37, wherein said material is OSB.

44. The material of claim 37, wherein said material is a paper.

45. A system for treating materials, comprising a wash, a primer and a paint, each comprising the composition of claim 1.
